(19) United States
(12) Patent Application Publication
(10) Pub. No.: US 2010/0141425 A1
(43) Pub. Date: Jun. 10, 2010

(54) DEVICE SECURITY SYSTEM

(75) Inventors: JAMES B. A. TRACEY, Austin, TX (US); JAMES E. BURKE, Austin, TX (US); ROY PAUL PROSISE, Cedar Park, TX (US); HAYWARD VERDUN, Franklin, LA (US)

Correspondence Address: KNOBBE MARTENS OLSON & BEAR LLP, 2040 MAIN STREET, FOURTEENTH FLOOR, IRVINE, CA, 92614, US

(73) Assignee: GREAT STUFF, INC., Austin, TX (US)

(21) Appl. No.: 12/569,825

(22) Filed: Sep. 29, 2009

Related U.S. Application Data
(60) Provisional application No. 61/101,613, filed on Sep. 30, 2008.

(51) Int. Cl. G08B 21/00; G08B 1/08

(52) U.S. Cl. 340/539.1; 340/686.1; 340/669

(57) ABSTRACT

One embodiment involves a usage code system comprising an electrical device powered by a battery only if the battery contains a characteristic usage code. Another embodiment involves a presence confirmation device that repeatedly sends wireless query signals. The electrical device receives the query signals and responds by sending a wireless confirmation signal to the presence confirmation device. The presence confirmation generates an alert if it does not receive the confirmation signal after a certain time period after sending a query signal to the electrical device. Yet another embodiment involves a motion sensor that measures motion data from which translation of an electrical device is determined. If a net translation of the device is greater than or equal to a defined threshold, an alert system generates an alert or increases a polling rate at which new motion data is periodically received from the motion sensor.

### CLAIM FOR PRIORITY

The present application claims priority to U.S. Provisional Patent Application No. 61/101,613, filed Sep. 30, 2008, the entirety of which is hereby incorporated herein by reference.

### INCORPORATION BY REFERENCE

The present application incorporates by reference the entire disclosures of U.S. Pat. Nos. 6,279,848; 7,021,583; 7,320,843; 7,350,736; 7,503,338; and 7,533,843; and U.S. Patent Application Publication Nos. US2005/0011968A1 and US2008/0223951A1.

### BACKGROUND OF THE INVENTION

1. Field of the Invention

The present application relates to systems and methods for regulating usage of electrical devices.

2. Description of the Related Art

Certain types of outdoor devices, such as garden devices, have significant value. For example, some outdoor hose reel systems include advanced motor-control systems, integrated valve systems and valve control features, remote control operability, and programming functionality. These attributes considerably increase the value of the hose reel systems.

Certain types of utilitarian outdoor devices are designed to have aesthetic appeal. Some outdoor devices have evolved from mere utilitarian items to essentially artistic items. For example, hose reels have been designed to take the appearance of animals, fanciful characters, and the like. Such aesthetic appeal increases the value of these devices and makes them greater targets for theft.

Unfortunately, garden devices such as hose reels can be relatively easily stolen. While the risk of theft can be reduced by chaining or otherwise securing an outdoor device to a building or other immovable fixture, such measures often reduce the utility of the device and/or its aesthetic appeal. Also, it is sometimes not possible to secure the outdoor device at all.

### SUMMARY OF THE INVENTION

In one embodiment, the present application provides an apparatus comprising a body, a motion sensor, and an alert system. The body is substantially stationary during normal usage of the apparatus. The motion sensor is configured to measure motion data from which translation of the body can be determined. The alert system has an armed state and a disarmed state. In the armed state, the alert system is configured to receive the motion data from the motion sensor, use the received motion data to detect a net translation of the body, and respond to a determination that the net translation of the body is greater than or equal to a defined threshold by generating an alert or by increasing a polling rate at which the alert system periodically receives new motion data from the motion sensor.

In another embodiment, the present application provides a presence confirmation system for one or more electrical devices, comprising at least one electrical device and a presence confirmation device configured to repeatedly send wireless query signals to the electrical device. The electrical device is configured to receive the query signals from the presence confirmation device, and to respond to receiving each query signal by sending a wireless confirmation signal to the presence confirmation device. The presence confirmation device is configured to generate an alert if the presence confirmation device does not receive the confirmation signal within a certain time period after sending a query signal to the electrical device.

In another embodiment, the present application provides a presence confirmation device comprising a transceiver and an alert generator. The transceiver is configured to repeatedly send wireless query signals to an electrical device, and to receive wireless confirmation signals from the electrical device. Each confirmation signal confirms that the electrical device received a previous query signal from the transceiver. The alert generator is configured to generate an alert if the transceiver does not receive a confirmation signal within a certain time period after the transceiver has sent a query signal to the electrical device.

In another embodiment, the present application provides an apparatus comprising an electrical device, a transceiver on or within the electrical device, and an electronics component. The transceiver is configured to receive a wireless query signal and to respond to receiving the query signal by transmitting a wireless confirmation signal. The electronics component is configured to disable the electrical device if the electrical device does not receive a query signal for a certain period of time.

In another embodiment, the present application provides a method of confirming the presence of one or more electrical devices, comprising repeatedly sending wireless query signals to an electrical device, and responding to failing to receive a wireless confirmation signal from the electrical device within a certain time period after sending one of the query signals by generating an alert.

In another embodiment, the present application provides a method comprising receiving wireless query signals from a presence confirmation device, responding to each of the query signals by sending a wireless confirmation signal to the presence confirmation device, and responding to a failure to receive a wireless query signal for a certain period of time by disabling an electrical device until a wireless query signal is received.

In another embodiment, the present application provides a shut-off system for an electrical device, comprising an electrical device and a battery. The electrical device comprises a power terminal and an electronics component. The battery is configured to be electrically connected to the power terminal for electrically powering the electrical device and electronically communicating with the electronics component. The battery has a memory for storing a characteristic usage code associated with the electrical device. The electrical device and the battery are configured such that the battery transmits the usage code to the electronics component when the battery is electrically connected to the power terminal. The electronics component is configured to maintain the electrical device in an inoperable mode if the battery is electrically connected to the power terminal without the usage code stored in the memory. The electronics component is configured to subsequently switch the electrical device from the inoperable mode to an operable mode only if the battery is electrically connected to the power terminal with the usage code stored in the memory.

In another embodiment, the present application provides a battery for powering an electrical device, comprising a battery body and a memory within the battery body. The memory stores a characteristic usage code required for operation of an electrical device.

In another embodiment, the present application provides an apparatus comprising an electrical device, an electronics component on or within the electrical device, and a power terminal configured to electrically connect to a battery for electrically powering the electrical device. The power terminal is configured to enable electronic communication between the electronics component and a battery electrically connected to the power terminal. The electronics component is configured to switch the electrical device to an inoperable mode unless (1) a battery is electrically connected to the power terminal, and (2) the battery transfers a characteristic usage code to the electronics component when the battery is electrically connected to the power terminal.

In another embodiment, the present application provides a battery charger, comprising a battery charging site, a charger memory, and an electronics component. The battery charging site electrically powers a battery electrically connected to the charging site. The charger memory stores a characteristic usage code associated with an electrical device that requires the usage code to be operable. The electronics component is configured to transfer the usage code from the charger memory to a memory of a battery when the battery is electrically connected to the battery charging site.

In another embodiment, the present application provides a method of preventing unauthorized usage of an electrical device. The method comprises providing an electrical device with a power terminal, the electrical device requiring a characteristic usage code for operation; providing a battery for electrically powering the electrical device when the battery is electrically connected to the power terminal, the battery including a memory; electrically connecting the battery to the power terminal of the electrical device without the usage code stored in the memory of the battery; and responding to the electrical connection of the battery to the power terminal by preventing or disabling operation of the electrical device.

In another embodiment, the present application provides a method comprising electrically connecting a battery to a battery charger, electrically charging the battery while the battery is electrically connected to the charger, and transferring a characteristic usage code from a memory of the charger to a memory of the battery while the battery is electrically connected to the charger. The usage code is required for the battery to electrically power and make operable an electrical device.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a schematic illustration of an embodiment of an outdoor electrical device and a battery.

FIG. 2 is a schematic illustration of the battery of FIG. 1 with an embodiment of a battery charger.

FIG. 3 is a flowchart illustrating an embodiment of a method of regulating usage of an outdoor electrical device.

FIG. 4 is a flowchart illustrating an embodiment of a method of electrically charging a battery.

FIG. 5 is a flowchart illustrating an embodiment of a method for transferring a characteristic usage code onto a battery memory.

FIG. 6 is a schematic illustration of an embodiment of a presence confirmation system for confirming the presence of one or more outdoor electrical devices.

FIG. 7 is a flowchart of an embodiment of a method of operating an alert system for a presence confirmation system.

FIG. 8 is a flowchart of an embodiment of a method of regulating usage of the outdoor electrical device of the flowchart of FIG. 7.

FIG. 9 is a perspective view of an outdoor reel with a motion sensor, with a housing portion removed.

FIG. 10 is perspective view of a leg of the reel of FIG. 9, with the motion sensor removed.

FIG. 11 is a disassembled perspective view of the leg of FIG. 10.

FIG. 12 is an exploded perspective view of one embodiment of an alert system.

FIG. 13 is a front view of one embodiment of a face plate.

FIG. 14 is a front view of an alternative embodiment of the face place.

FIG. 15 is a schematic view of one embodiment of alarm circuitry of the alert system.

FIGS. 16A and 16B (together referred to herein as “FIG. 16”) collectively show a flowchart of an embodiment of a method of operating the alert system of the outdoor electrical device.

FIGS. 17A and 17B (together referred to herein as “FIG. 17”) collectively show a flowchart of an alternative embodiment of a method of operating the alert system of the outdoor electrical device.

FIG. 18 is a state diagram of an embodiment of the alert system of the outdoor electrical device.

### DETAILED DESCRIPTION OF THE PREFERRED EMBODIMENTS

The present application discloses shut-off systems and alert generation systems intended to discourage the theft of outdoor electrical devices, such as hose reel systems, valve systems, and the like. Three general embodiments are a usage code shut-off system, a presence confirmation system, and a motion sensor system, which are described below. Although these embodiments are discussed in separate sections, this is done so merely for purposes of illustration. Persons of ordinary skill in the art will recognize that any combination of these systems may be utilized to enhance the security of outdoor electrical devices. Furthermore, while this application describes these embodiments in the context of electrical devices that are outdoor, it will be appreciated that the principles described herein apply equally to electrical devices that are indoor, and the latter are intended to be covered by this application.

### Usage Code Shut-Off System

In this general embodiment, an outdoor electrical device preferably requires a usage code for operability. The usage code is characteristic of the particular outdoor device, in that the device requires that particular usage code for operation. The usage code can be completely unique to the outdoor device, or alternatively can be one of a plurality of usage codes used by like devices. The usage code can be delivered to the outdoor device via electrical connection with a particular battery power source. The battery can be configured to erase the usage code either upon depletion of electrical charge or during recharging, and to recover the usage code only by being recharged by a battery charger configured with the characteristic usage code. In this configuration, the theft of the outdoor device with the battery therein will preferably ultimately result in inoperability of the outdoor device when the battery is partially or wholly depleted of electrical charge, thus discouraging such theft.

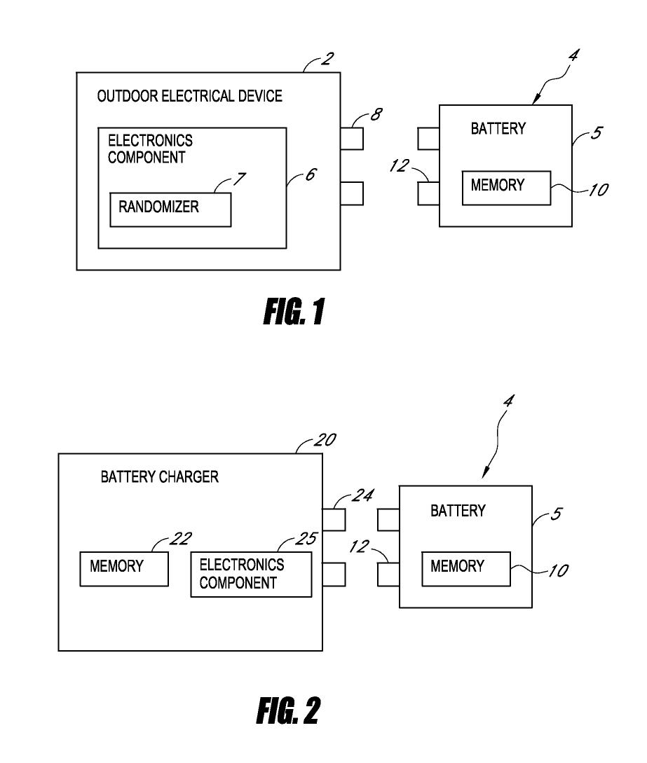

FIGS. 1-5 illustrate a system and methods for shutting off an outdoor electrical device by employing a usage code, in accordance with one embodiment. FIG. 1 is a schematic illustration of an embodiment of a battery-powered outdoor electrical device 2 and a battery 4 for electrically powering the outdoor device 2. The outdoor device 2 includes an electronics component 6 and a power terminal 8. The illustrated battery 4 includes a body 5 and a power terminal 12 on the body 5. The power terminal 8 of the outdoor device 2 is preferably configured to be electrically connected to the power terminal 12 of the battery 4. In the illustrated embodiment, the power terminals 8 and 12 each comprise a pair of electrodes, as known in the art. However, the power terminal 8 can be configured for any suitable method of electrical power delivery. In certain embodiments, the power terminal 8 comprises a slot for receiving the battery 4, while in other embodiments the power terminal 8 is received within in a slot of the battery 4. Of course, other physical arrangements and configurations of the power terminal 8 and the battery 4 are possible as long as they permit electrical power delivery.

In certain embodiments, the outdoor electrical device 2 of FIG. 1 comprises a battery-powered reel system for spooling a linear material such as a hose or electrical wire. Such a reel system can include a rotatable element or drum onto which a linear material may be spooled, and a reel housing that may be decorated for aesthetic appeal. Examples of decorated reel housings are described in U.S. Pat. No. 7,021,583. In certain embodiments, the reel system comprises a hose reel. In certain embodiments, the hose reel includes a valve system for controlling water flow through a hose spooled on the hose reel. Examples of hose reels with valve systems are described in U.S. Patent Application Publication No. US2005/0011968A1 and U.S. Pat. No. 7,503,338. In certain embodiments, the reel includes a remote control that controls the rotation of the rotatable element or drum, and/or the valve system if the spooled linear material is a hose. Examples of reels with remote controls are described in U.S. Pat. No. 7,503,338. In certain embodiments, the reel system includes a motor-controller that controls the rotation of the rotatable element or drum onto which the linear material is spooled. Examples of reels having motor-controllers are described in U.S. Pat. No. 7,350,736. Examples of battery-powered reels are described in U.S. Pat. No. 7,320,843.

Referring still to FIG. 1, the electronics component 6 is preferably configured to control operability of the outdoor device 2. In particular, the electronics component 6 can be configured to switch the outdoor device 2 between operable and inoperable modes. In the operable mode, the outdoor device 2 can be used for its ordinarily intended purposes. For example, if the outdoor device 2 is a motorized hose reel with an electronically controlled valve system, then the operable mode can allow a user to operate the motor to wind or unwind a hose with respect to the reel, as well as adjust the valve system to regulate water flow through the hose. The electronics component 6 can comprise a computer motherboard and associated elements, such as a computer processor chip. The electronics component 6 can comprise software and/or firmware.

The inoperable mode of the outdoor device 2 preferably prevents a user from using the device 2 for its ordinarily intended purposes. In certain embodiments, the inoperable mode prevents a user from electrically activating the outdoor device 2. In another embodiment, the inoperable mode allows the outdoor device 2 to be electrically activated but does not permit the device 2 to perform some or all of its intended functionality. For example, if the outdoor device 2 is a motorized hose reel with an electronically controlled valve system, then the inoperable mode can prevent a user from operating the motor to wind or unwind a hose with respect to the reel, as well as prevent the user from adjusting the valve system.

In a preferred embodiment, the outdoor electrical device 2 requires the input of a usage code for operation. In the illustrated embodiment, the electronics component 6 requires the usage code to switch the outdoor device 2 to the operable mode.

With continued reference to FIG. 1, the battery 4 is preferably configured to be electrically connected to the power terminal 8 of the outdoor electrical device 2 for electrically powering the outdoor device 2 and electronically communicating with the electronics component 6. The battery 4 can include a power terminal 12 configured to electrically contact the power terminal 8 to effect a flow of electrical current from the battery 4 to the outdoor device 2. In the illustrated embodiment, the power terminal 12 comprises a pair of electrodes, as known in the art. The battery 4 preferably has a memory 10 within the battery body 5, for storing the characteristic usage code associated with the outdoor device 2. For example, the memory 10 can comprise a flash drive. In some embodiments, the memory 10 is formed integrally with the battery 4, while in other embodiments the memory 10 is designed to be removable and replaceable by a user. Preferably, the outdoor device 2 and the battery 4 are configured such that the battery 4 transmits the usage code from the memory 10 to the electronics component 6 when the battery 4 is electrically connected to the power terminal 8.

The electronics component 6 of a particular outdoor electrical device 2 can be configured to switch the outdoor device 2 to its inoperable mode if the battery 4 is electrically connected to the power terminal 8 without the required usage code for that device 2 stored in the battery's memory 10. The electronics component 6 can also be configured to switch the outdoor device 2 from the inoperable mode to the operable mode only if the battery 4 is electrically connected to the power terminal 8 with the required usage code stored in the memory 10.

The battery 4 can be configured so that the usage code is erased from the memory 10 only when the battery 4 is substantially or completely depleted of electrical charge, or alternatively when the battery's electrical charge falls below a certain threshold. In such an embodiment, even if the outdoor electrical device 2 and battery 4 are stolen, the usage code will eventually be erased from the memory 10 when the electrical charge decreases. Thus, the outdoor device 2 will eventually switch to its inoperable mode, rendering it useless for its intended purposes.

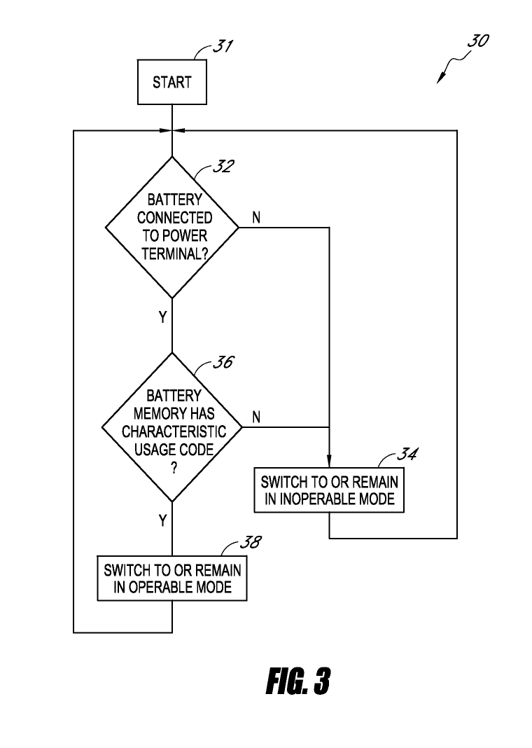

Referring still to FIG. 1, it is contemplated that a plurality of different outdoor electrical devices 2 may be provided, the devices using a plurality of different usage codes. For example, a manufacturer of the devices 2 may use a finite number of usage codes for the devices 2, each device 2 using only one of the usage codes. In one approach, each manufactured device 2 has a unique usage code, such that no two devices 2 share the same usage code. In another approach, it is possible that two devices may share the same usage code, but preferably a large number of usage codes are used by the manufacturer. It is further contemplated that each outdoor device 2 will be paired with a particular battery charger 20 (described below with reference to FIG. 2) that provides the characteristic usage code for that particular outdoor device 2. In a preferred embodiment, if the outdoor device 2 is stolen without the battery 4 therein, the device 2 cannot be operated. Even if the thief has a different battery 4 (perhaps from another outdoor device 2), said different battery 4 will not have the appropriate usage code.

FIG. 2 is a schematic illustration of the battery 4 of FIG. 1 with an embodiment of a battery charger 20. The battery charger 20 is preferably configured to electrically charge the battery 4 when the battery 4 is electrically connected to a battery charging site 24 of the charger 20. In the illustrated embodiment, the battery charging site 24 comprises a pair of electrodes configured to electrically contact electrodes of the battery 4, as known in the art.

The battery charger 20 is also preferably configured to transmit the characteristic usage code to the battery's memory 10 when the battery 4 is electrically connected to the battery charging site 24. In certain embodiments, as mentioned above, the battery 4 is configured so that the usage code is erased when the electrical charge stored in the battery 4 either drops below a certain threshold or becomes substantially depleted. The battery charger 20 then refreshes the characteristic usage code when the battery 4 is recharged.

In certain embodiments, the battery charger 20 has a charger memory 22 that stores the characteristic usage code that the outdoor electrical device 2 requires for operability. The battery charger 20 can also have an electronics component 25 configured to transfer the usage code from the charger memory 22 to the memory 10 of the battery 4 when the battery 4 is electrically connected to the battery charging site 24.

With reference to FIGS. 1 and 2, it is contemplated that the outdoor electrical device 2 and the battery charger 20 can be provided in pairs, wherein the device/charger pairs use different usage codes. In certain embodiments, each such device/charger pair uses a unique usage code, or alternatively a usage code that is one of a multitude of different usage codes employed by like devices 2 and chargers 20. This effectively prevents a thief from using a stolen outdoor device 2 with an unpaired battery charger 20. For example, suppose there exists first and second pairs of outdoor devices 2 and battery chargers 20, the first pair comprising an outdoor device 2A and a battery charger 20A, and the second pair comprising an outdoor device 2B and a battery charger 20B. Suppose further that the first device/charger pair uses a usage code A and the second device/charger pair uses a usage code B that is different than usage code A. If a thief steals the outdoor device 2A and tries to power it with a battery 4 charged by the battery charger 20B, the battery's memory 22 will store the usage code B. However, the outdoor device 2A requires the usage code A for operation. Thus, the thief cannot operate the stolen outdoor device 2A without the battery charger 20A.

In certain embodiments, the battery 4 is a non-standard battery that can only be recharged by a specific type of battery charger 20. This prevents a thief from recharging the battery without the required battery charger 20. Moreover, a stolen outdoor device 2 is preferably not usable with a battery charger 20 other than the specific charger 20 paired with the outdoor device 2.

In certain embodiments, the battery charger 20 can be configured to erase the usage code from the battery's memory 10 when the battery 4 is electrically connected to the battery charging site 24. The battery charger 20 can further be configured to replace the erased usage code with the characteristic usage code associated with the outdoor device 2. This feature may be provided whether or not the code gets erased upon depletion of charge in the battery, as described above. This embodiment prevents a thief from using a stolen outdoor device 2 with a battery charger 20 other than the specific battery charger 20 associated with the stolen device 2. Without this feature, it might be possible for a thief to steal an outdoor device 2 and battery 4 having therein stored the characteristic usage code associated with the stolen device 2, and then continue using the stolen device 2 by recharging the battery 4 with a different battery charger 20 before its electrical charge drops enough to cause the usage code to become erased from the battery's memory 10. In this embodiment, the different battery charger 20 will erase the usage code from the stolen battery's memory 10 every time the battery is recharged, thus preventing usage of the stolen battery with the stolen outdoor device 2.

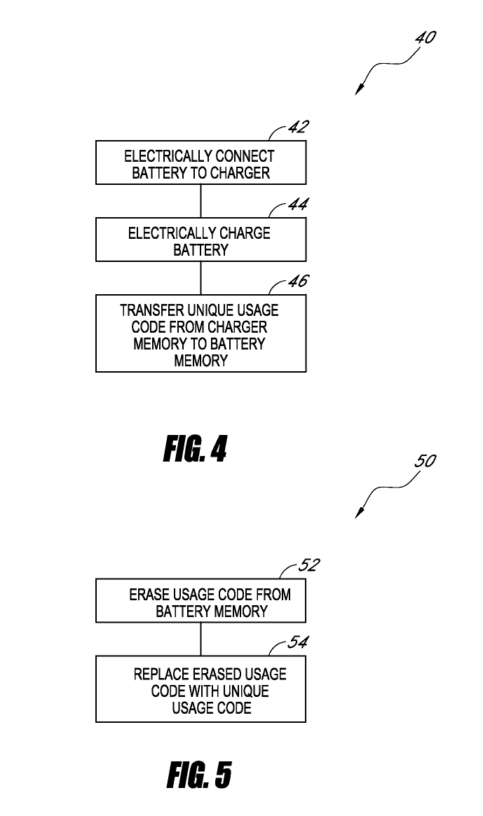

Reference is now made to FIGS. 1 and 3. FIG. 3 is a flowchart illustrating an embodiment of a method 30 of regulating usage of an outdoor electrical device 2, from the point of view of the outdoor device 2. With reference to FIGS. 1 and 3, the method begins at a step 31, which may involve, for example, an attempt by a user to turn on or operate the outdoor device 2. In a decision step 32, the outdoor device 2 ascertains whether a battery 4 is electrically connected to the power terminal 8. For example, the electronics component 6 can employ a logic unit and/or software/firmware to make this determination. If a battery 4 is not electrically connected to the power terminal 8, then the outdoor device 2, in a step 34, switches to or remains in its inoperable mode, and then the method 30 returns to the decision step 32. On the other hand, if a battery 4 is electrically connected to the power terminal 8, then the method 30 proceeds to a decision step 36, in which the outdoor device 2 ascertains whether the battery's memory 10 has the required characteristic usage code stored therein. If not, then the outdoor device 2, in the step 34, switches to or remains in its inoperable mode, and then the method 30 returns to the decision step 32. On the other hand, if the battery's memory 10 has the required usage code stored therein, then the outdoor device 2, in a step 38, switches to or remains in its operable mode. After the step 38, the method 30 returns to the decision step 32.

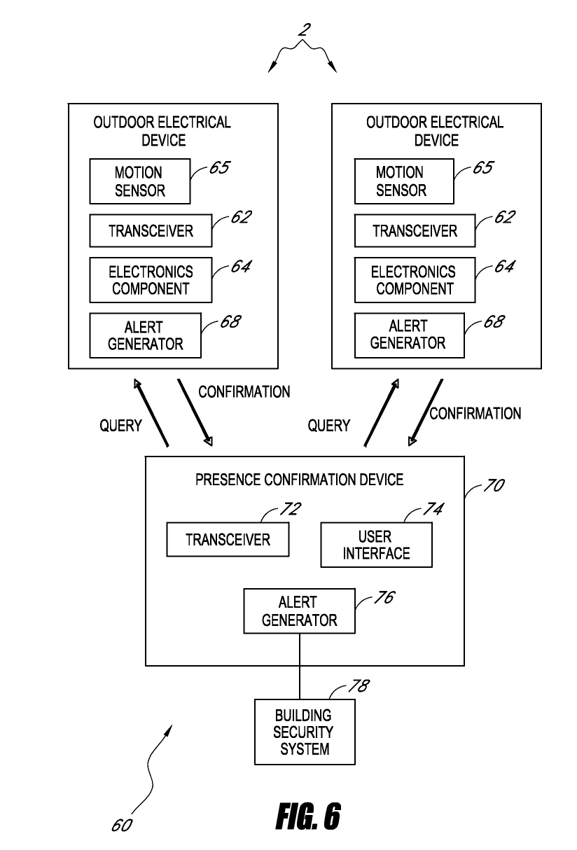

Reference is now made to FIGS. 2 and 4. FIG. 4 is a flowchart illustrating an embodiment of a method 40 of electrically charging a battery 4 with a battery charger 20. The illustrated method 40 involves electrically connecting the battery 4 to the battery charger 20 in a step 42. For example, the battery's power terminal 12 can be connected to the battery charging site 24 of the battery charger 20. In a step 44, the battery charger 20 electrically charges the battery 4. For example, the battery charger 20 can be configured to draw electrical power from a conventional electrical power outlet for charging the battery 4. In a step 46, the battery charger 20 transfers its characteristic usage code from the memory 22 to the battery's memory 10. For example, the battery charger's electronics component 25 can perform the transfer of the usage code.

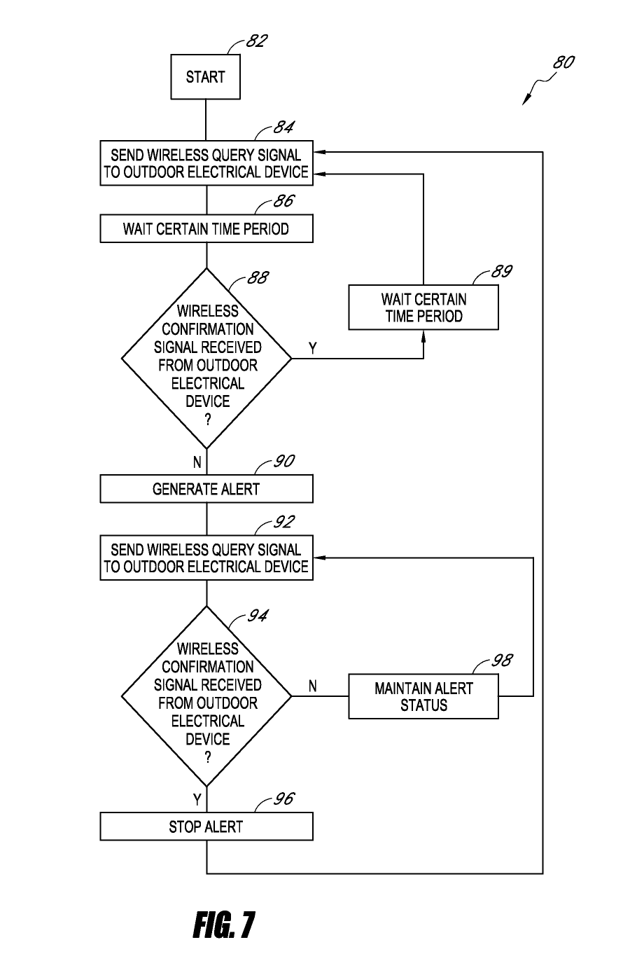

Reference is now made to FIGS. 2 and 5. FIG. 5 is a flowchart illustrating an embodiment of a method 50 for transferring a characteristic usage code from the battery charger 20 to a battery memory 10. In certain embodiments, the method 50 can replace step 46 of FIG. 4. The method 50 is preferably conducted when the battery 4 is in electrical connection with the battery charger 20. The illustrated method 50 involves, in a step 52, erasing the usage code from the battery's memory 10. Then, in a step 54, the erased usage code is replaced with the characteristic usage code associated with the battery charger 20. The steps 52 and 54 can be conducted at least partially by the electronics component 25 of the battery charger 20. It will be understood that step 54 can involve replacing the erased usage code with the exact same usage code if the battery 4 was last charged by the same battery charger 20. It will also be understood that step 54 can involve replacing the erased usage code with a different usage code if the battery 4 was last charged by a different battery charger 20.

Referring again to FIG. 1, in some embodiments each outdoor device 2 has an electronic randomizer 7 that randomly selects a usage code when the reel is initially setup and activated. The illustrated randomizer 7 comprises a component of the electronics component 6, although the randomizer can alternatively be separate from the component 6. The randomly selected code becomes the characteristic usage code associated with the device 2, as described above. In one embodiment, the device 2 and/or battery 4 stores the randomly selected usage code in the battery 4. In one embodiment, the randomly selected code is stored in the battery by connecting the battery's terminal 12 with the outdoor device's power terminal 8 in accordance with a defined protocol involving the randomizer. A possible manufacturing method includes manufacturing a plurality of outdoor devices 2, and providing in each outdoor device a common “production code” or “master code,” wherein each device 2 is configured to become reset upon receiving the master code. In this context, becoming reset preferably includes the ability to pair the device 2 with a new battery 4. For example, each device 2 can be configured to switch from the inoperable mode to a fully operable mode upon receiving the master code, after which the device's randomizer can select a new usage code. Devices 2 can receive the master code through the power terminal 8 or in any other suitable manner. In one embodiment, each device has a dedicated user interface for receiving the master code, such as a keypad, flash memory port, and/or software interface, etc.

### Presence Confirmation System

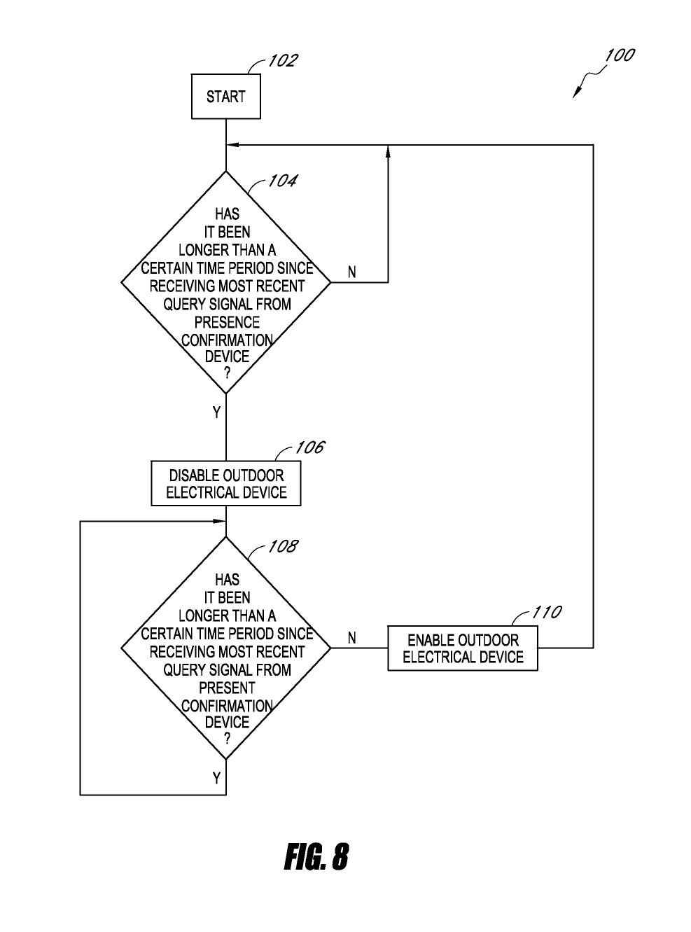

In this general embodiment, which is generally illustrated by FIGS. 6-8, a presence confirmation device, such as a home computer or battery charger, communicates wirelessly with at least one outdoor electrical device to confirm that the outdoor device is within a certain physical proximity. In certain embodiments, the outdoor device is configured to switch to an inoperable mode when it is no longer within such proximity to the presence confirmation device. As a result, a stolen outdoor device will shut down and become unusable. In certain embodiments, the presence confirmation device confirms the local presence of the outdoor device by sending a query signal to the outdoor device, and the outdoor device responds by sending a confirmation signal back to the presence confirmation device. If the presence confirmation device does not receive the confirmation signal, it can be configured to generate an alert.

FIG. 6 is a schematic illustration of an embodiment of a presence confirmation system 60 for confirming the presence of one or more outdoor electrical devices 2. The system 60 includes two outdoor electrical devices 2 and a presence confirmation device 70. While the illustrated embodiment includes two outdoor devices 2, it will be understood that the system 60 can involve any number of such devices.

The presence confirmation device 70 is preferably configured to repeatedly send wireless query signals to the outdoor electrical devices 2. In the illustrated embodiment, the presence confirmation device 70 has a transceiver 72 configured to repeatedly send the wireless query signals (as well as other types of wireless signals, discussed below) to the outdoor devices 2. Skilled artisans will understand that the presence confirmation device 70 can have a certain limited communication range. In other words, in some embodiments the wireless query signals cannot effectively travel beyond a certain distance or radius, which effectively defines the proximity within which the presence confirmation device 70 can confirm the presence of the outdoor devices 2. For example, the wireless signals sent from the presence confirmation device 70 can comprise, without limitation, radio frequency (RF) signals. Such wireless signals can be compatible with, for example, IEEE 802.XX standards, Bluetooth standards, wireless phone standards (e.g., 800 MHz, 900 MHz, 1.9 GHz, 2.8 GHz, or 5.6 GHz), or any frequency permitted by Federal Communications Commission rules, including 47 C.F.R. Part 15 Rules. In certain embodiments, the presence confirmation device 70 is capable of sending wireless signals no further than, for example, about 25-30 feet, 50 feet, or 100 feet. In certain embodiments, the communication range of the presence confirmation device 70 is adjustable by the user.

Referring still to FIG. 6, in the illustrated embodiment each outdoor electrical device 2 is configured to receive the wireless query signals from the presence confirmation device 70. In the illustrated embodiment, a transceiver 62 on or within each outdoor device 2 is configured to receive the wireless signals from the presence confirmation device 70. In a typical arrangement, the outdoor devices 2 can only receive the wireless signals if the outdoor devices 2 are located in the particular communication range or radius of the presence confirmation device 70. Each outdoor device 2 is further preferably configured to respond to receiving each query signal by sending a wireless confirmation signal to the presence confirmation device 70. In certain embodiments, each transceiver 62 is configured to respond to receiving a wireless query signal by transmitting the wireless confirmation signal. The outdoor devices 2 preferably have a communication range that is equivalent to or greater than that of the presence confirmation device 70. If not, then the presence confirmation device 70 would not receive a confirmation signal from an outdoor device 2 that is at the outer perimeter of the communication range of the presence confirmation device 70. The wireless confirmation signals can comprise, for example and without limitation, any of the wireless communication signal types mentioned above for the wireless query signals transmitted from the presence confirmation device 70.

By receiving the wireless confirmation signal from a particular outdoor electrical device 2, the presence confirmation device 70 confirms that that particular outdoor device 2 is located within a certain communication range of the presence confirmation device 70. In certain embodiments, the transceiver 72 is configured to receive the wireless confirmation signal from the outdoor device 2. Each confirmation signal confirms that the outdoor device 2 received a previous wireless query signal from the transceiver 72.

In certain embodiments, the presence confirmation device 70 is configured to generate an alert if it does not receive the wireless confirmation signal within a certain time period after sending the wireless query signal to the outdoor electrical device 2. In the illustrated embodiment, the presence confirmation device 70 includes an alert generator 76 configured to generate an alert if the transceiver 72 does not receive the confirmation signal within a certain time period after the transceiver 72 has sent a query signal to the outdoor device 2. The alert can be a conventional audible alert to warn the owner or user of the outdoor device 2 of the possible non-presence of the outdoor device 2 within the communication range of the presence confirmation device 70. In certain embodiments, the presence confirmation device 70 cooperates or communicates with a building security system 78 in a manner allowing the building security system 78 to broadcast the alert. Alternatively, the alert can be non-audible, such as a flashing light or a signal sent to a home security monitoring service.

In certain embodiments, the presence confirmation device 70 comprises a computer system, such as a home computer, laptop computer, personal digital assistant (PDA), or mobile phone. In certain embodiments, this type of presence confirmation device 70 and the outdoor electrical devices 2 can communicate with a wireless modem network or a cellular network. In certain embodiments, a computer-type presence confirmation device 70 can run specialized software for sending the wireless query signals, receiving the wireless confirmation signals, and generating the alerts. In this embodiment, the alert can comprise, without limitation, an email, text message, or voice message regarding the non-presence of the outdoor electrical device 2 within the communication range of the presence confirmation device 70.

In certain embodiments, the outdoor electrical device 2 is programmed to switch to an inoperable mode if it does not receive a wireless query signal from the presence confirmation device 70 for a certain period of time. For example, each outdoor device 2 can have an electronics component 64 configured to disable the device 2 under such circumstances. This prevents a thief from using a stolen outdoor device 2 without the presence confirmation device 70. It is contemplated that a plurality of different outdoor devices 2 and presence confirmation devices 70 can be provided. It is further contemplated that each outdoor device 2 can be configured to respond only to the wireless query signals of one particular presence confirmation device 70. In certain embodiments, each wireless query signal includes a characteristic identification code associated with the particular presence confirmation device 70 that sends the query signal. Further, each outdoor device 2 can be configured or programmed to shut down and become inoperable if it does not receive a wireless query signal having that particular characteristic identification code for a certain time period. Moreover, each outdoor device 2 can be configured or programmed to send a wireless confirmation signal only if it receives a wireless query signal having the characteristic identification code of the particular presence confirmation device 70. These measures help prevent a thief from using a stolen outdoor device 2 with a different presence confirmation device 70.

It is contemplated that a plurality of different groupings of presence confirmation devices 70 and outdoor electrical devices 2 may be provided, each grouping including one device 70 and one or more devices 2. Further, each grouping can use one characteristic identification code for its presence confirmation device, as described above. It is contemplated that a manufacturer of the devices 2 and 70 may use a finite number of characteristic identification codes, each grouping using only one of said codes. In one approach, each grouping has a unique characteristic identification code for its presence confirmation device 70, such that no two groupings share the same code. In another approach, it is possible that two groupings may share the same characteristic identification code for their presence confirmation devices 70, but preferably a large number of such codes are used by the manufacturer.

Referring still to FIG. 6, the illustrated presence confirmation device 70 includes a user interface 74 configured to receive user instructions or commands. For example, the user interface 74 can comprise a keypad, touchpad, keyboard, voice-recognition system, computer mouse, and/or display screen. In certain embodiments, the user interface 74 is configured to receive user instructions for switching an outdoor electrical device 2 between operable and inoperable modes. The presence confirmation device 70 can be configured to respond to receiving such user instructions by sending a wireless shut-down signal or a wireless turn-on signal to the outdoor device 2. In certain embodiments, the wireless shut-down signal or turn-on signal is sent from the transceiver 72 of the presence confirmation device 70 and received by the transceiver 62 of the outdoor device 2. In such an embodiment, the outdoor device 2 can be configured to respond to receiving the wireless signal by switching between its operable and inoperable modes. In certain embodiments, the outdoor device 2 switches between said modes only if the wireless shut-down signal or turn-on signal includes the characteristic identification code of the particular presence confirmation device with which the outdoor device 2 is paired.

In certain embodiments, the presence confirmation device 70 comprises a computer system connected to the Internet, and a user can download software (e.g., applets) for additional or advanced functionality. In one implementation, the device 70 acts as a router or communication hub (e.g., WiFi link) for communicating with a home computer or laptop. In another implementation, the device 70 can have a motherboard with a CPU, working memory, hard drive, user interface, display screen, etc. One example of advanced functionality that can be achieved is to supplement the memory capacity of the outdoor device 2. For example, the outdoor device 2 may have a chipset with a limited random access memory (RAM), and a memory capacity of the computer system of the presence confirmation device 70 can be used to supplement the memory of the device 2. For instance, if the outdoor device 2 is a programmable reel for a water hose system, the user may want to program a very detailed watering process extending over a long period of time (e.g., several months), which may require more memory than available on the outdoor device 2. Examples of programmable reels for water hose systems are disclosed in U.S. Patent Application Publication No. US2008/0223951A1. Further, the computer system of the presence confirmation device 70 can facilitate the downloading, installation, and execution of software updates (e.g., automatic software updates) for control, maintenance, and/or programming of the outdoor device 2, as it may be somewhat difficult to download software directly onto the device 2. Additionally, the computer system of the presence confirmation device 70 can be used to conduct diagnostic testing of the outdoor device. For example, the computer system can be used to determine a remaining life of a battery that electrically powers the outdoor device 2. In another example, the computer system of the presence confirmation device 70 can facilitate the uploading of information (e.g., warranty information, product version, etc.) from the outdoor device 2 to a computer system controlled by a manufacturer or repair service.

As explained above, an outdoor electrical device 2 can comprise a garden device, such as a motorized reel for spooling linear material, and/or an electrically controlled valve system for controlling fluid flow through a hose. The outdoor device 2 can additionally include a remote control configured to control the valve system. A motorized reel can comprise a hose reel for spooling hose. The remote control can also be configured to control a hose reel. In some embodiments, the presence confirmation device 70 comprises a battery charger configured to recharge a battery of the outdoor device 2, such as the charger 20 and battery 4 shown in FIG. 2.

In certain embodiments, the user interface 74 of the presence confirmation device 70 is configured to receive a user-generated program for future activities of the outdoor electrical device 2. For example, if the outdoor device 2 includes a valve system, the program can comprise instructions for future movements and operations of the valve system. If the outdoor device includes a motorized reel, the program can comprise instructions for future movements of the reel, such as wind and/or unwind movements of a rotatable element or drum onto which a linear material is spooled. The presence confirmation device 70 can be configured to wirelessly transmit the program to the outdoor device 2, for example to a computer memory thereof.

Reference is now made to FIGS. 6 and 7. FIG. 7 is a flowchart of an embodiment of a method 80 of operating an alert system for the presence confirmation system 60 of FIG. 6. It will be understood that not all of the illustrated steps are required, and that this method can be modified without departing from the spirit and scope of the invention. The illustrated method 80, depicted from the point of view of a presence confirmation device 70, starts at 82. In an ensuing step 84, the presence confirmation device 70 sends a wireless query signal to at least one outdoor electrical device 2. The wireless query signal can be sent from the transceiver 72. Next, in step 86, the presence confirmation device 70 waits a certain time period. A wait time helps to prevent the generation of an alert immediately after sending the wireless query signal. In certain embodiments, the time period associated with step 86 can be, for example, 1-5 seconds.

Next, in a decision step 88, the presence confirmation device 70 determines whether a wireless confirmation signal has been received (e.g., by the transceiver 72) from an outdoor electrical device 2. The reception of a wireless confirmation signal from an outdoor device 2 indicates that that particular outdoor device 2 is located within the communication range of the presence confirmation device 70. If multiple outdoor devices 2 are polled, then the wireless query signals and/or wireless confirmation signals may include separate codes uniquely identifying each outdoor device 2, relative to the other devices 2 that are polled. That way, the presence confirmation device 70 can be configured to determine which outdoor devices 2 have responded to its queries, and which outdoor devices 2 have not responded. If the answer to the inquiry in the decision step 88 is yes, then the method 80 proceeds to a step 89, in which the presence confirmation device 70 waits another time period, for example 1-10 seconds, or 10-30 seconds. After waiting out the time period associated with step 89, the method 80 returns to step 84, in which the presence confirmation device 70 sends another wireless query signal to the outdoor device 2. Thus, the presence confirmation device 70 continuously monitors for the local presence of the outdoor device 2 by repeatedly transmitting the wireless query signals. Skilled artisans will appreciate that step 89 is not required. However, it may be desirable to wait a certain time period between decision step 88 and step 84, because it is likely not necessary to monitor for the local presence of the outdoor device 2 immediately after confirming such presence.

With continuing reference to FIGS. 6 and 7, if the answer to the inquiry in the decision step 88 is no, then an alert is generated in a step 90, preferably by the alert generator 76. As mentioned above, the alert can comprise, without limitation, an audible alert, a non-audible alert such as a flashing light or a signal sent to a monitoring service, and/or an email or text message. Also, the alert can be generated or broadcast by a building security system 78.

In an alternative approach, steps 84, 86, 88, and 90 can be modified so that the presence confirmation device 70 sends a series of wireless query signals (e.g., every 10-100 milliseconds) for a certain time period (e.g., 3-5 seconds), and generates an alert if no response is received from the outdoor device 2 in said certain time period.

The remaining steps of the method 80 are intended to determine whether to stop the alert condition. In a step 92, after the alert generation step 90, the presence confirmation device 70 sends another wireless query signal to the particular outdoor electrical device 2 whose non-response generated the alert. For example, each outdoor device 2 can have a characteristic identifier that distinguishes it from the other devices 2 of the grouping, and each device 2 can be configured to respond only to wireless signals that include its particular identifier. Then, in a decision step 94, the presence confirmation device 70 determines whether a wireless confirmation signal has been received from that particular outdoor device 2. If not, then the alert status is maintained in step 98, and the method 80 returns to step 92. On the other hand, if the answer to the inquiry in decision step 94 is yes, then the presence confirmation device 70 terminates the alert condition in step 96. Step 96 may include informing a person or monitoring service that the particular outdoor device 70 is present within the communication range of the presence confirmation device 70. After step 96, the method 80 returns to step 84.

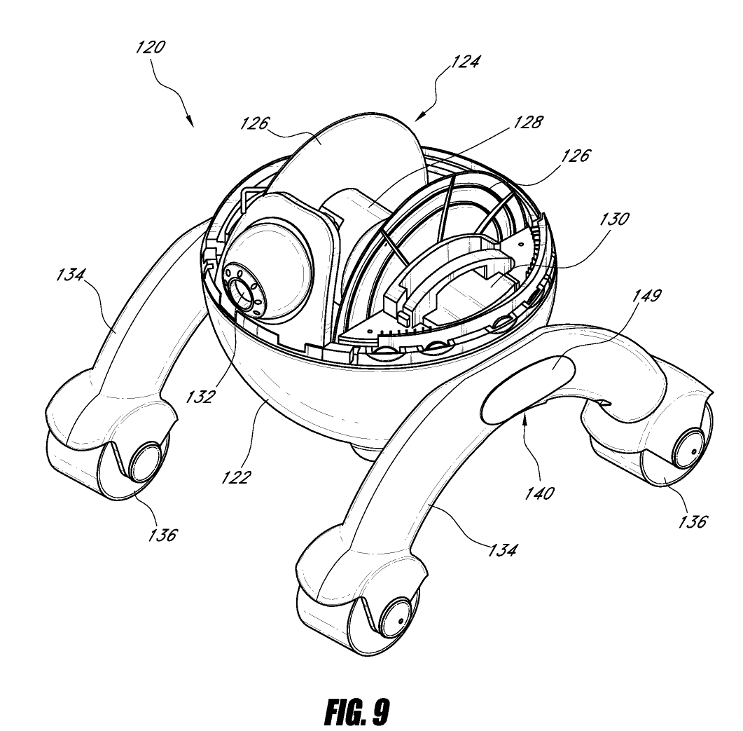

Reference is now made to FIGS. 6 and 8. FIG. 8 is a flowchart of an embodiment of a method 100 of regulating usage of an outdoor electrical device 2 of FIG. 6. It will be understood that this method can be modified without departing from the spirit and scope of the invention. The illustrated method 100, depicted from the point of view of an outdoor device 2, starts at 102. In an ensuing decision step 104, the outdoor device 2 determines whether it has been longer than a certain time period since the outdoor device 2 (e.g., the transceiver 62) received a most recent wireless query signal from the presence confirmation device 70. For example, the time period associated with decision step 104 can be 5 minutes, 30 minutes, one hour, etc. If the answer to the inquiry in decision step 104 is no, then the method 100 simply repeats decision step 104. In other words, the method 100 involves continuously asking whether a wireless query signal has been received within the previous, e.g., 30 minutes. If the answer is yes, then the outdoor device 2 disables itself in a step 106 by switching to its inoperable or “shut-down” mode.

Then, in a decision step 108, the outdoor electrical device 2 again determines whether it has been longer than a certain time period since the outdoor device 2 received a most recent wireless query signal from the presence confirmation device 70. If so, then the outdoor device 2 simply repeats decision step 108. In other words, once the outdoor device 2 is disabled, it continues to monitor for an incoming wireless query signal. If such a signal is received, then the answer to the inquiry in decision step 108 is no, then the outdoor device 2 re-enables itself in a step 110 by switching to its operable mode. The method 100 then returns to decision step 104.

With reference still to FIG. 6, it may be desirable to prevent instances in which the presence confirmation system 60 generates alerts even when the outdoor device 2 is within the communication range of the presence confirmation device 70. For example, the wireless communications between the presence confirmation device 70 and outdoor device 2 may be blocked or hindered by intervening structures or geographies, which may cause the presence confirmation device 70 to conclude that the outdoor device 2 is out of the communication range of the presence confirmation device 70. These “false alarms” are undesirable and preferably minimized. Accordingly, certain embodiments reduce false alarms by employing motion sensors within the outdoor devices 2. The motion sensors provide additional data that is useful in determining whether a theft of the outdoor device 2 is occurring or has already occurred.

Referring again to FIG. 6, each outdoor electrical device 2 may include a motion sensor 65 configured to detect motion of the device 2. As used herein, a motion sensor may include devices that detect displacement, velocity, and/or acceleration, it being understood that certain of these parameters can be calculated from the others, possibly in combination with other data. An example of a motion sensor 65 is an accelerometer. In one embodiment, the motion sensor 65 is not sensitive to minute motions, such as vibrations caused by nearby moving vehicles, strong breezes, rain, contact with small animals, and the like. However, the motion sensor 65 is preferably configured to detect more significant movements of the outdoor device 2. For example, the motion sensor 65 can be configured to detect human-initiated movements, such as a person carrying the device while walking, or instances in which the device is dragged by a vehicle. The motion sensor 65 can preferably respond to a detected motion of the outdoor device 2 by generating and/or transmitting a wireless motion sensor signal indicative of the detected motion. For example, the motion sensor 65 can respond to a detected motion of the device 2 by sending a signal to the transceiver 62, which then transmits the signal wirelessly. The motion detection signal can be received, for example, by the presence confirmation device 70.

In one embodiment, the alert generator 76 of the presence confirmation device 70 generates an alert only in response to the following sequence of events. First, the presence confirmation device 70 must receive a wireless motion sensor signal from an outdoor device 2. The motion sensor signal originates from the motion sensor 65 and is indicative of a movement of the outdoor device 2. Such movement can be legitimate (e.g., movement by the owner of the device 2) or illegitimate (movement due to an attempted theft of the device). Since the movement may be legitimate, it is not preferred to generate an alert at this point. Second, the presence confirmation device 70 must send a query signal to the outdoor device 2 after receiving the motion sensor signal. Third, the presence confirmation device 70 must fail to receive a confirmation signal from the outdoor device 2 within a certain time period after sending the query signal. If all three of these events occur, then the alert generator 76 preferably generates an alert as described above.

In certain embodiments, the outdoor device 2 can be configured to switch to its inoperable mode when the motion sensor 65 detects motion of the device 2. For example, the outdoor device 2 may be configured to switch to its inoperable mode only if a motion is detected and the transceiver 62 fails to receive a query signal from the presence confirmation device 70 within a predetermined time period after detecting the motion.

Referring again to FIG. 6, in some embodiments at least one of the outdoor electrical devices 2 includes an alert generator 68 configured to generate an alarm if the motion sensor 65 detects motion of the outdoor device 2. For example, the alert generator 68 can sound an audible alarm. Alternatively, the alert generator 68 can another type of alarm or alert status, such as a flashing light, email, text message, or the like. For example, the alert generator 68 may instruct the transceiver 62 to send a wireless message to an associated computer system that generates an email alert, or to an associated telephony device that generates a text message. Of course, hardware and/or software for generating an email and/or a text message can alternatively be provided in the outdoor device itself, if desired.

In one implementation, the alert generator 68 generates an alarm only if (1) the motion sensor 65 detects motion of the outdoor device 2, and (2) within a predefined time period after the detected motion, the transceiver 62 fails to receive a wireless query signal from the presence confirmation device 70 with a signal strength above a predefined threshold. Thus, if a thief steals the outdoor device 2, the motion sensor 65 will detect the motion. Once the thief carries the outdoor device 2 beyond a certain distance from the presence confirmation device 70, the signal strength of the query signals from the device 70 will fall below the predefined threshold, and the alert generator 68 will sound its alarm or initiate an alert as described above. This particular implementation avoids the generation of an alert merely due to movement of the outdoor device 2, because such movement can be caused by reasons other than theft. For example, the movement can be caused by the owner of the outdoor device 2, by small animals, high winds, etc.

In certain embodiments, the outdoor electrical device 2 can have and use a motion sensor 65 and alert generator 68 even in the absence of a presence confirmation device 70. In such embodiments, the alert generator 68 can be configured to generate an alert when the motion sensor 65 detects movement of the outdoor device 2. In one approach, the alert generator 68 only generates an alert if the motion sensor 65 detects motion occurring for longer than a predetermined length of time.

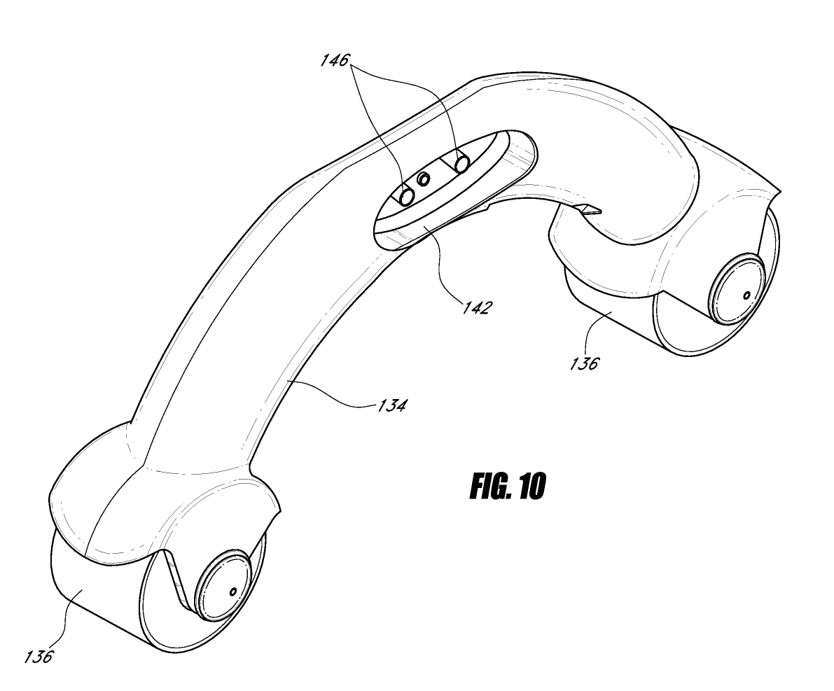

FIGS. 9-11 are perspective views of an outdoor electrical reel 120 for spooling linear material, such as electrical cord or hose, in accordance with one embodiment. The reel 120 comprises one embodiment of an outdoor electrical device 2, as described above. The illustrated reel 120 includes a pair of semispherical housings, of which a lower housing 122 is shown. Additional examples of reels having two semispherical housings are shown in U.S. Pat. Nos. 6,279,848 and 7,533,843. The two semispherical housings enclose a reel assembly comprising a rotatable element 124, a battery 130, and a motor (not shown) adapted to produce rotation of the rotatable element 124. The illustrated rotatable element 124 is a drum that includes a pair of side plates 126 sandwiching a cylindrical member 128 onto which the linear material is wound or unwound, depending upon a direction of drum rotation. The upper semispherical housing includes an aperture 132 through which the linear material is drawn as it is wound or unwound with respect to the rotatable element 124. Further details concerning the configuration and operation of the illustrated reel assembly are disclosed in U.S. Pat. No. 7,533,843.

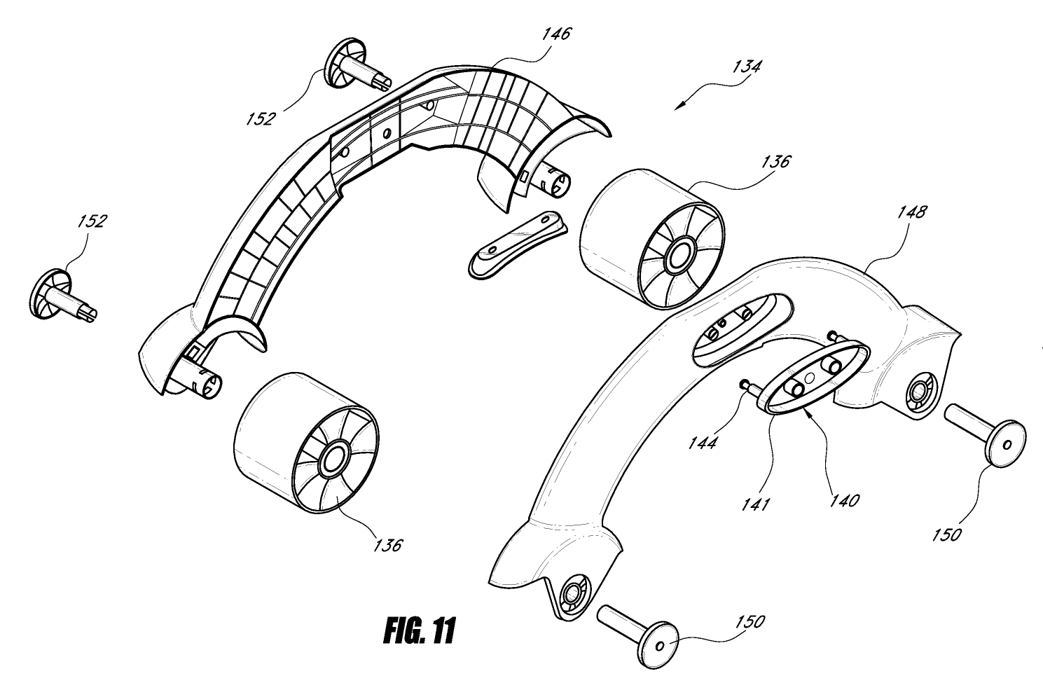

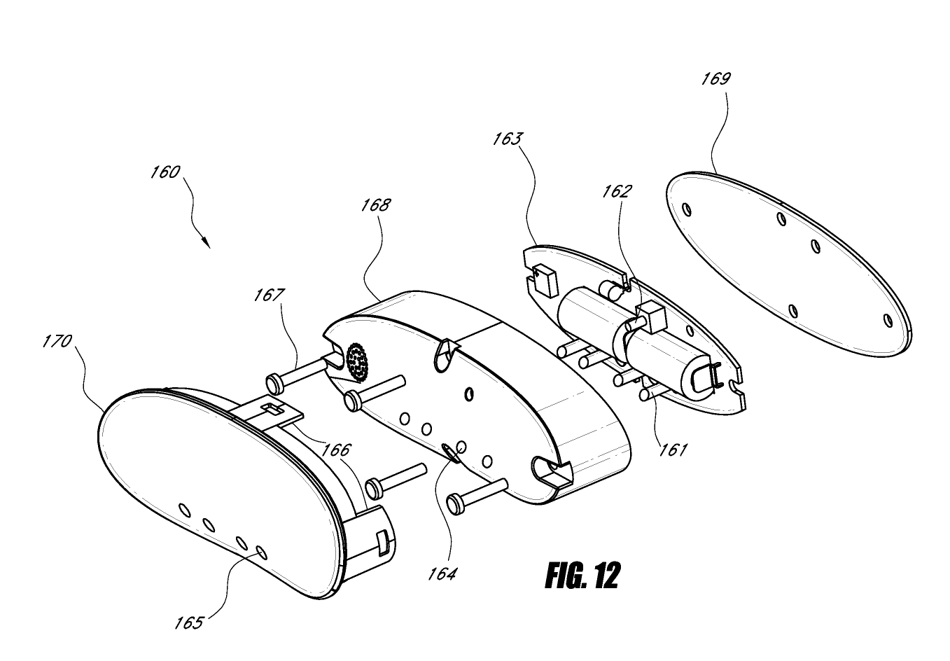

The illustrated reel 120 also includes a pair of legs 134, each having a pair of wheels 136. In one embodiment, one of the legs 134 includes a motion sensor 140 as described above. Persons of ordinary skill in the art will recognize that there are many different suitable methods of securing the motion sensor 140 to a body of an outdoor device, and in this case the leg 134. It will be understood that the motion sensor 140 can be used in conjunction with a device body that is substantially stationary during normal usage of the outdoor device, or alternatively with a device body that moves during normal usage. As shown in FIGS. 10 and 11, in one particular embodiment each leg 134 has an inner half 146 and an outer half 148, the latter including a recess 142 sized and configured to receive the motion sensor 140. In the illustrated embodiment, the motion sensor 140 includes a body 141 having a pair of elongated engagement portions 144, which can be adapted to be inserted into a corresponding pair of channels 146 in the recess 142. When so inserted, the engagement portions 144 lock the body 141 to the leg 134, such as by a snap-fit connection or by bolts or screws via an opposite side of the outer leg half 148. Referring to FIG. 9, the motion sensor 140 may comprise also comprise a cover plate 149 that covers and protects the internals of the motion sensor 140. The cover plate 149 preferably engages the body 141 by a snap-fit connection. In the illustrated embodiment, the wheels 136 are secured between the leg halves 146 and 148 via axle portions 150 and 152, as will be understood by those in the art.

In an alternative embodiment, the outdoor device 2 includes a pair of accelerometers. As known in the art, the use of two single-axis accelerometers can provide not only motion detection, but also direction and speed of motion information. Such information can be sent wirelessly to the presence confirmation device 70, which can generate an alert as described above, and also provide the user with said direction and speed information.

In another embodiment, the outdoor device 2 can include a gyroscope, possibly in addition to one or more accelerometers. As known in the art, a gyroscope can provide information about current location. The outdoor device 2 can send such information to the presence confirmation device 70, which can in turn convey that data to a user.

In another embodiment, the presence confirmation system employs a proximity locator in each outdoor device 2. The proximity locator tells a base station whether the outdoor device 2 is located within a particular proximity of the base station. For example, such technology is employed in so-called “pet alarms.” In one approach, the base station includes an alert generator 76 (FIG. 6) that generates an alert when the proximity locator detects that the outdoor device is beyond a defined radius from the base station.

In another embodiment, a locator device is physically planted near the outdoor device 2. For example, the locator device can be a small component that may be buried underneath or in close proximity to the device 2. If the device 2 is moved away from the locator device beyond a defined distance, the locator device can be configured to generate an alert condition, either by sounding a local alarm or by sending a signal to a base station that itself activates an alert generator 76 (FIG. 6).

In another embodiment, an electrical continuity check system is provided for determining whether the outdoor device 2 has been moved. A continuity check system may employ an electrical communication line such as a metal cable, wire, a water path, etc., or some combination of such elements. In one approach, an electrical signal is generated for determining whether there has been a physical severing of a communication path from a first point to a second point, wherein the outdoor device 2 lies along said path. For example, the first and second points can be at or near a user's home. In a typical system, a first cable segment extends from the user's home to the outdoor device 2, and a second cable segment extends from the device 2 back to the user's home. In such a system, the first point is at an end of the first cable segment near the home, and the second point is at an end of the second cable segment also near the home. The continuity check system is configured to send an electrical signal from the first point toward the second point. If the signal returns, then the continuity check system assumes that the communication path has not been severed and that the outdoor device 2 has not been moved. If the signal does not return (infinite electrical resistance), then the continuity check system assumes that the communication path has been severed and that the outdoor device 2 has been moved. Under such condition, the continuity check system can be configured to generate an alert as described above.

### Motion Sensor System

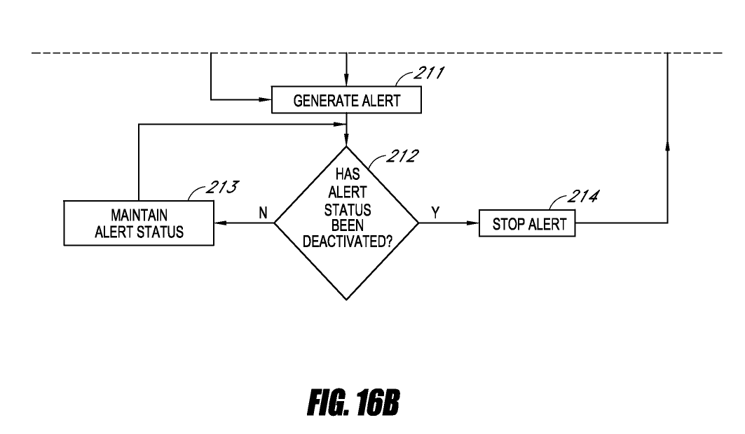

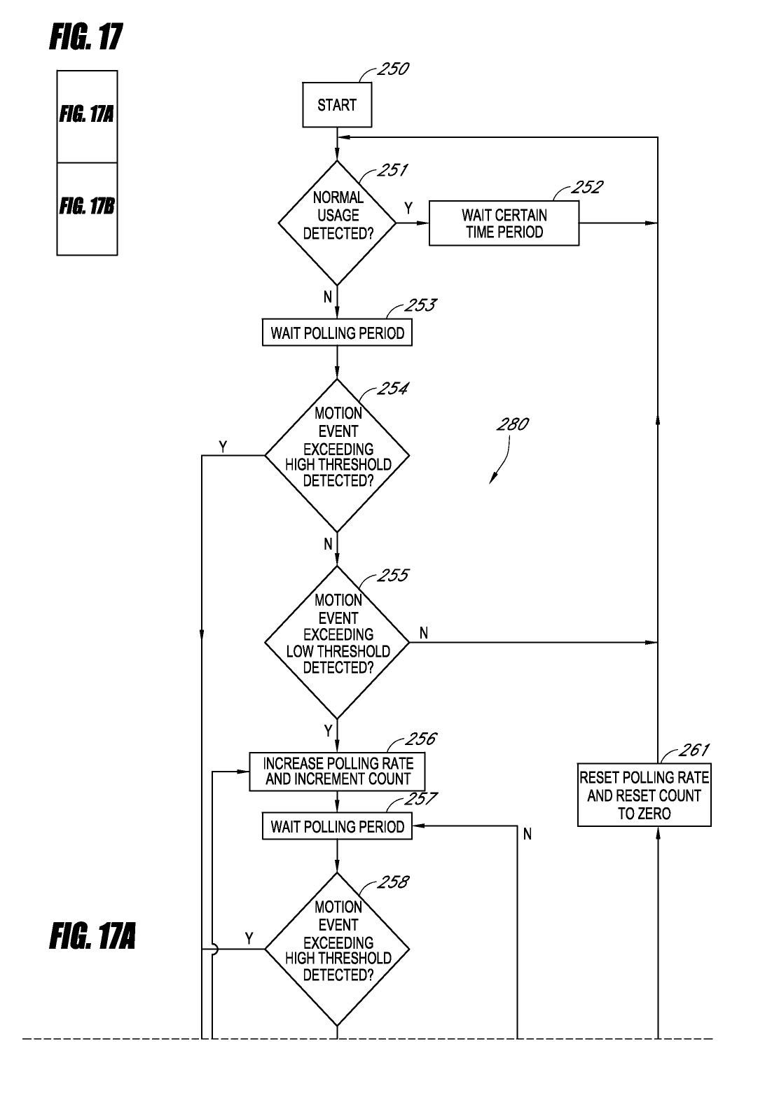

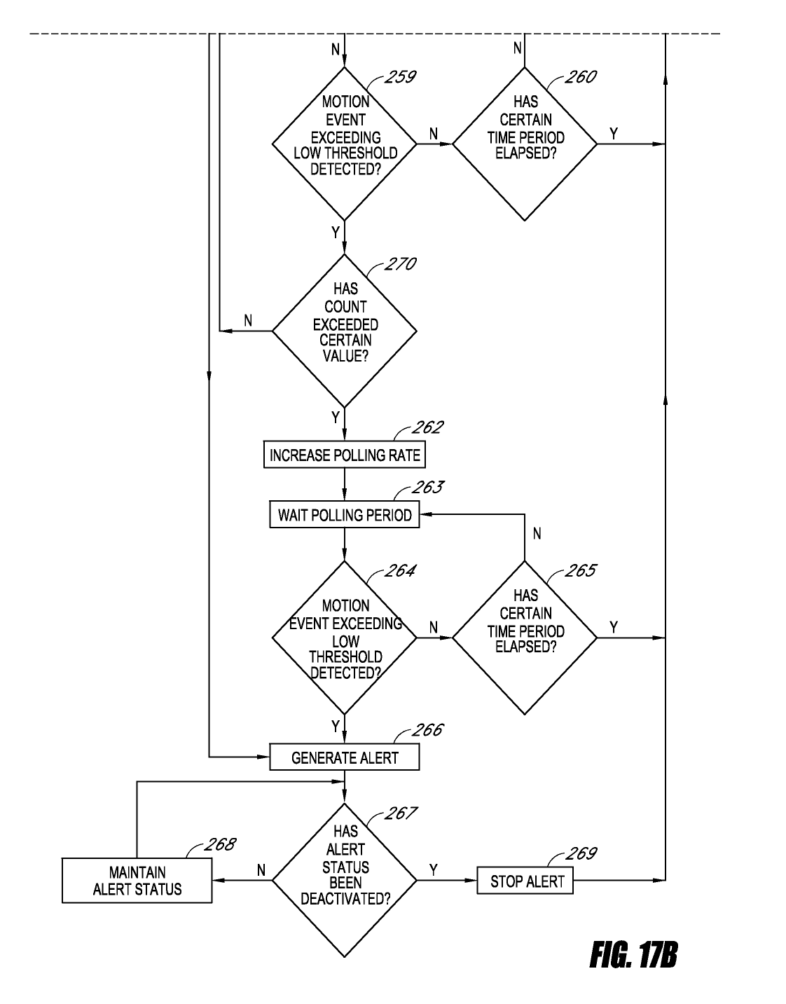

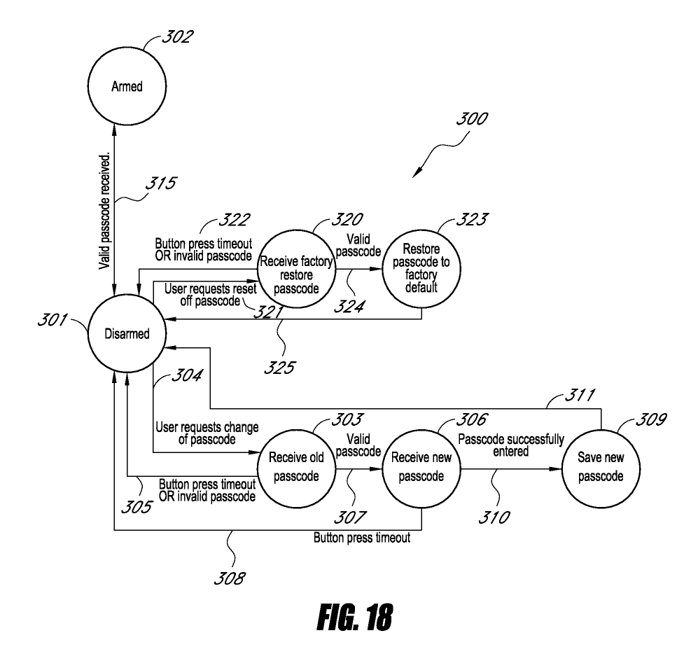

In this general embodiment, an outdoor electrical device preferably requires a motion sensor for operability. However, persons of ordinary skill in the art will recognize that many of the embodiments disclosed herein, such as the state diagram disclosed in FIG. 18 and the methods of operating an alert system illustrated in FIGS. 16 and 17, can be used in connection with the alert systems disclosed above. Additionally, persons of ordinary skill in the art will recognize that many of the previous security systems utilized motion detectors (see FIG. 6). For the purposes of illustration only, the embodiments disclosed herein are disclosed in the context of outdoor devices having one or more motion sensors.

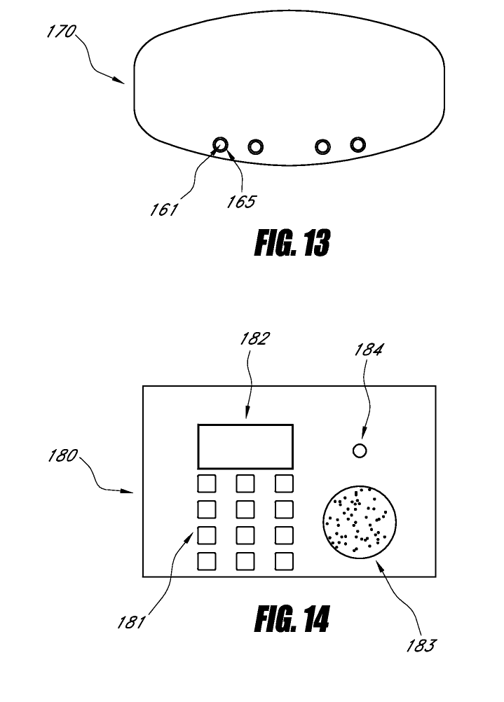

FIGS. 12-18 describe embodiments that may or may not include a presence confirmation device 70. FIG. 12 illustrates an exploded perspective view of one embodiment of an alert system for use in the outdoor device 2. The illustrated alert system 160 includes a back plate 169, alarm circuitry 163, a protective cover 168, and a face plate 170. In this embodiment, screws 167 secure the protective cover 168, the alarm circuitry 163, and the back plate 169 to the outdoor device 2. In one embodiment, the outdoor device 2 is the reel 120 including the pair of legs 134 as illustrated in FIG. 9, and the alert system 160 is secured to one of the legs 134. An optional switch 162 may be provided, which may comprise a rod or other type of element biased outward, such as by a spring. Once the screws 167 are secured, the switch 162 becomes depressed and thereby engaged. The switch 162 is preferably configured to initiate an alarm and/or alert when disengaged. If a thief removes the protective cover 168 (e.g., in an attempt to deactivate the alarm), the switch 162 will become disengaged and the alarm circuitry 163 will sound its alarm and/or initiate an alert. The face plate 170 is secured to the protective cover 168 by face plate clasps 166. The illustrated alert system 160 also includes buttons 161, which are operatively connected to the alarm circuitry 163 and exposed to a user for input through aligned protective cover apertures 164 and, optionally, face plate apertures 165. In certain embodiments, the buttons 161 permit a user to manually enter a passcode for arming or disarming the alert system.

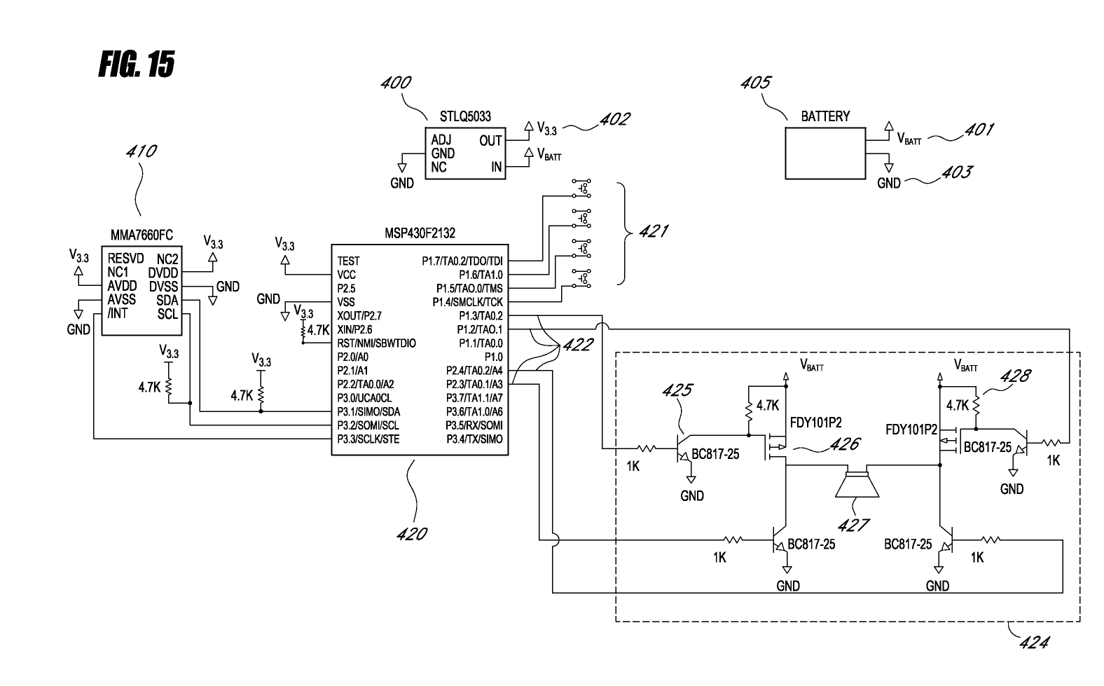

FIGS. 13-14 illustrate front views of two face plate designs. FIG. 13 illustrates a front view of the face plate 170. In this illustration, the buttons 161 are exposed to user input through the face plate apertures 165. Persons of ordinary skill in the art will recognize that there are many possible embodiments of alert systems, and that the face plate 170 illustrates one of many suitable face plates for the alert system 160 illustrated in FIG. 12. In alternative embodiments of alert systems, including those with or without the presence confirmation device 70, the face plate may have different appearance and configuration. With reference to FIG. 14, a face plate 180 exemplifies one of these possible alternative face plate designs. The face plate 180 has buttons 181 for input into the alert system. The buttons 181 could be of any number or style. Additionally, the face plate 180 has a display screen 182, a speaker 183, and an indicator light 184. One possible embodiment for indicator light 184 is an LED. Although the face plate 180 illustrates a single display screen 182, speaker 183, and indicator light 184, persons of ordinary skill in the art will recognize that any combination or number of these items could be present on the face plate 180.

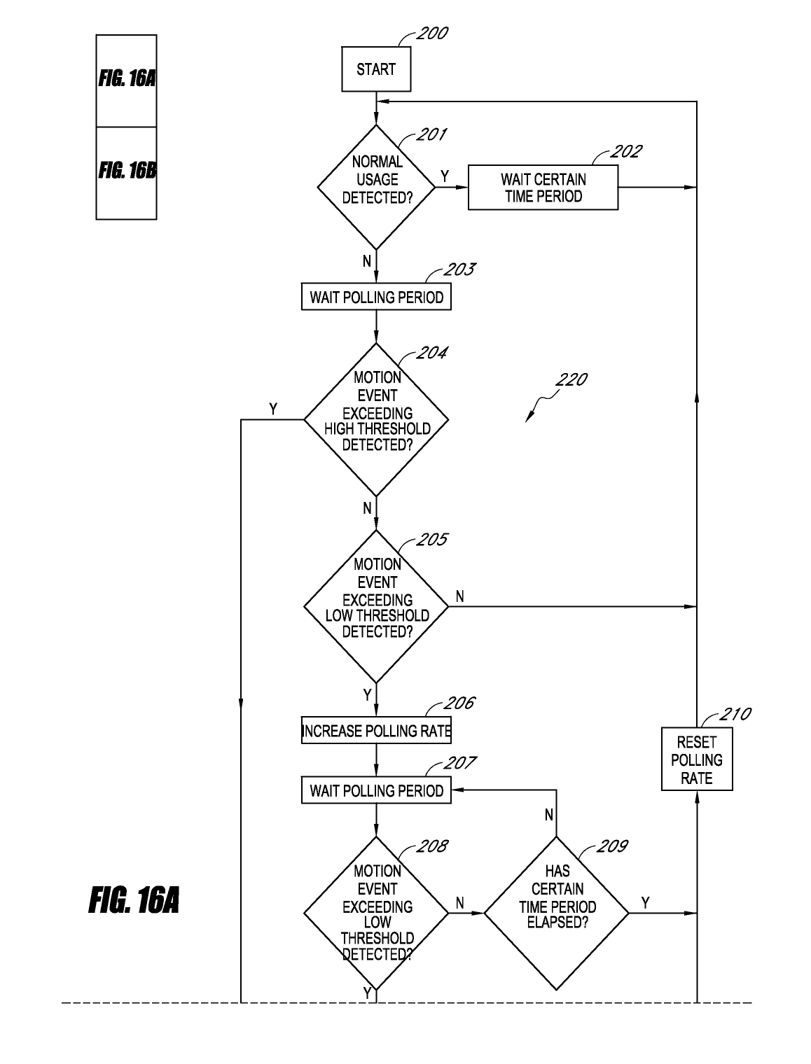

FIG. 15 illustrates a schematic view of one embodiment of the alarm circuitry 163 (FIG. 12) for use in the alert system 160. The illustrated alarm circuitry 163 includes a battery 405 that produces a battery voltage 401 with reference to a ground voltage 403. One example of the battery 405 is a 9-volt lithium battery. The alarm circuitry 163 also includes a linear regulator 400, which produces a regulated voltage 402 from the battery voltage 401. One example of the linear regulator 400 is part STLQ5033 produced by STMicroelectronics. The illustrated alarm circuitry 163 also includes an accelerometer 410. Preferably, the accelerometer 410 is a three-axis accelerometer capable of orientation and motion detection, such as part MMA7760FC from Freescale Semiconductor. As used herein, “motion detection” encompasses the detection of displacement, velocity, and/or acceleration, possibly by performing one or more computations based on measured data.

In the illustrated alarm circuitry 163 of FIG. 15, the accelerometer 410 communicates three-axis orientation and/or motion detection data to a microcontroller 420, either independently or at the request of the microcontroller 420. One possible implementation of the microcontroller 420 is part MSP430F2132 from Texas Instruments. The microcontroller 420 also receives user input from buttons 421. In one embodiment, the buttons 421 are board-mount membrane buttons actuated by a keypad. The buttons 421 might be used to input a variety of data from the user. In one embodiment, the buttons 421 are used by the user to input a passcode, and the microcontroller 420 compares this passcode to a stored code in a memory within the microcontroller 420. In this embodiment, the memory might be the flash memory within the microcontroller.

The microcontroller 420 uses the three-axis orientation and motion detection data from the accelerometer 410 to produce speaker control signals 422 for a speaker circuit 424. As persons of ordinary skill in the art will recognize, the illustrated speaker circuit 424 is an H-Bridge circuit composed of resistors 428, NPN transistors 425, PMOS transistors 426 and a speaker 427. However, the speaker circuit could also be, for example, any piezoelectric drive circuit. By changing the speaker control signals 422, the microcontroller 420 can apply voltage in either direction across the speaker 427, thus controlling the sound emitted from the speaker 427. A possible implementation of the speaker 427 could be a piezoelectric buzzer, which might be placed in a resonator chamber with or without a sound baffle. One possible choice for NPN transistors 425 is part BC817-25 from National Semiconductor, while a possible choice for PMOS transistors 426 is part FDY101PZ from Fairchild Semiconductor.

In FIG. 15, the connections between the various components of the illustrated alarm circuitry are illustrated with solid lines. Persons of ordinary skill in the art will recognize that where feasible, any of these signals connecting components could be implemented by either physical wires or wireless signaling.

Furthermore, with reference to FIG. 6, any of the signals between components of the outdoor electrical device 2 could be wireless or hard-wired. For example, in some embodiments the motion sensor 65 might communicate with electronics component 64 by wireless signals. In other embodiments, the motion sensor 65 might communicate with electronics components 64 by one or more hard-wires.

Reference is now made to FIGS. 16 and 17. FIGS. 16 and 17 are flowcharts directed generally toward certain embodiments of methods of operating an alert system in an outdoor device 2 that contains a motion sensor 65. In certain embodiments, the motion sensor is configured to measure motion data from which translation of a body of the outdoor device can be determined. Preferably, the motion sensor 65 is a three-axis accelerometer capable of orientation and motion detection, such as part MMA7760FC from Freescale Semiconductor. The illustrated methods of operating an alert system reduce both false alarms and power consumption of the outdoor device 2. The methods preferably avoid sounding an alarm or initiating an alert merely due to a single instance of movement of the outdoor device 2, unless such movement is particularly large, because movement can be caused by reasons other than theft. For example, the movement can be caused by the owner of the outdoor device 2, by small animals, high winds, etc. False alarms are undesirable because they require the attention of the owner of the outdoor device 2, and they result in a significant power drain on the outdoor device 2.

In addition to minimizing false alarms, the methods of operating an alert system illustrated in FIGS. 16 and 17 minimize power consumption of the outdoor device 2 while maintaining the desired security performance. A significant amount of power is consumed every time the outdoor device 2 processes motion data from the motion sensor 65. In embodiments where a presence confirmation device 70 is also present, additional power is consumed every time the outdoor device 2 sends motion data or other communications to the presence confirmation device 70. Accordingly, it is desirable to minimize the rate at which these activities take place. However, the integrity of the alert system is better served when the rate at which these activities take place is as high as possible. The methods illustrated in FIGS. 16 and 17 reduce power consumption, with minimal impact to security performance, by keeping the frequency of the above activities low until an event raising a suspicion of theft is detected.

FIG. 16 is a flowchart of an embodiment of a method 220 of operating an alert system of the outdoor device 2. The method is applicable whether or not the alert system has the presence confirmation device 70 of FIG. 6. It will be understood that not all of the illustrated steps are required, and that this method can be modified without departing from the spirit and scope of the invention. The illustrated method 220, depicted from the point of view of the alert system of the outdoor device 2, starts at 200. In an ensuing step 201, the alert system determines if the outdoor device 2 is being used in normal operation by a user. In making this determination, a variety of factors can be evaluated. In some embodiments, whether or not the reel 120 of FIG. 9 is in motion will be a factor. If the answer to the inquiry in the decision step 201 is yes, then the method 220 proceeds to a step 202, in which the alert system waits a time period, for example 1-10 seconds, or 10-30 seconds. In this case, the method 220 then returns to the decision step 201.

If the answer to the inquiry in the decision step 201 is no, then the method 220 proceeds to a step 203, in which the alert system waits another time period, for example 0.1-1 second, or 1-10 seconds. After waiting this period, referred to as the polling period, the method 220 proceeds to a decision step 204, in which the alert system determines whether or not there has been a motion event meeting or exceeding a “high threshold” within the last polling period.

In making this determination, the alert system compares motion data from the motion sensor 65 and compares it to stored high threshold data. In one embodiment, the motion sensor 65 is a three-axis accelerometer capable of orientation and/or motion detection, such as part MMA7760FC from Freescale Semiconductor. The three-axis accelerometer preferably detects acceleration components along three different axes, from which a three-dimensional acceleration vector can be computed. The high threshold is preferably a relatively large magnitude of the three-dimensional acceleration vector. In other words, a determination that the accelerometer's measurements meet or exceed the high threshold can mean, in certain embodiments, that the magnitude of the computed acceleration vector meets or exceeds a high threshold value for said magnitude. This means that the high threshold can be met even if the outdoor device 2 does not move along one or two separate axes, so long as it moves sufficiently along at least one other axis (e.g., high horizontal movement but no vertical movement).

In certain embodiments, a determination that the accelerometer's measurements meet or exceed the high threshold can alternatively or additionally mean that one, two, or all three of the magnitudes of the acceleration components along three separate axes (e.g., x-axis, y-axis, and z-axis) meet or exceed corresponding high thresholds for those axes. It will be understood that these high “acceleration component thresholds” can differ from one another. In certain implementations, the acceleration component threshold (high or low, see below) for one or two of the three axes can be less than the acceleration component threshold for the remaining one or two axes. In some embodiments, a high vertical (z-axis) acceleration component threshold of the vector is less than the high horizontal (x- and y-axes) acceleration component thresholds, preferably by a factor of, for example, 1-5 or 5-50. In other words, a determination that the accelerometer's readings meet or exceed the high threshold preferably requires less z-axis acceleration than x-axis and y-axis acceleration. Requiring less vertical (z-axis) acceleration component threshold of the three-dimensional acceleration vector before initiating an alarm or alert is particularly desirable, because vertical acceleration is more highly correlated with lifting the outdoor device 2 off the ground, which often occurs during theft.

In another embodiment, a determination that the accelerometer's measurements meet or exceed the high threshold can be determined by comparing the result of an equation to the high threshold, wherein the acceleration components along the separate axes are inputs into the equation. For example, one such equation could be the Euclidean norm of the acceleration vector (the square root of the dot product of the acceleration vector with itself). Use of this equation, or another equation which calculates the combined vector magnitude of the acceleration vector across multiple axes, is useful for detecting vector acceleration that might be below the threshold for any given axis. In certain implementations, the vertical (z-axis) acceleration component is scaled by a factor of, for example, 1-5, or 5-50, before being inputted into the equation. For example, if the equation were the Euclidean norm of the acceleration vector, the vertical (z-axis) acceleration could be scaled by the factor discussed above before taking the dot product of the acceleration vector with itself.

In another embodiment, the motion sensor 65 is a three-axis accelerometer as described above, and the high threshold corresponds to a magnitude of a three-dimensional displacement vector, computed by so-called “dead reckoning” (as known in the accelerometer field). In other words, a determination that the accelerometer's measurements meet or exceed the high threshold can mean, in certain embodiments, that the magnitude of the computed displacement vector meets or exceeds a high threshold value for said magnitude.

In some embodiments utilizing displacement data from the accelerometer, the accelerometer is configured to keep track of the origin of the coordinate system from which initial displacement is measured. In some of these embodiments, the accelerometer resets its reference point for displacement to (0, 0, 0) every time the alert system is armed (see FIG. 18, and the discussion accompanying it). In other embodiments, the accelerometer resets its reference point for displacement to (0, 0, 0) every time the alert system wakes up and receives power, such as when the regulated voltage 402 becomes active. In certain embodiments, the accelerometer resets its reference point for displacement to (0, 0, 0) after a certain number of readings, for example 1000-10,000, or 10,000 to 100,000. In other embodiments, the accelerometer resets its reference point for displacement to (0, 0, 0) every so often, for example after 10-100 seconds, or 100 seconds to 1 hour, or 1 hour to 1 day.

In another embodiment, a determination that the accelerometer's measurements meet or exceed the high threshold can alternatively or additionally mean that one, two, or all three of the magnitudes of the displacement components along three separate axes (e.g., x-axis, y-axis, and z-axis) meet or exceed corresponding high displacement thresholds for those axes. It will be understood that these high “displacement component thresholds” can differ from one another. In certain implementations, the displacement component threshold (either the high or low threshold, as described herein) for one or two of the three axes can be less than the displacement component threshold for the remaining one or two axes. In some embodiments, a high vertical (z-axis) displacement component threshold of the displacement vector is lesser than the high horizontal (x- and y-axes) displacement component thresholds, preferably by a factor of, for example, 1-5 or 5-50. In other words, a determination that the accelerometer's readings meet or exceed the high threshold preferably requires lesser z-axis displacement than x-axis and y-axis displacement.

In certain embodiments, a determination that the accelerometer's measurements meet or exceed the high threshold can be determined by comparing the result of an equation to the high threshold, wherein the displacement components along the separate axes are inputs into the equation. For example, one such equation could be the Euclidean norm of the displacement vector (the square root of the dot product of the displacement vector with itself). Use of this equation, or another equation which calculates the combined vector magnitude of the displacement vector across multiple axes, is useful for detecting vector displacement that might be below the threshold for any given axis. In certain implementations, the vertical (z-axis) displacement component is scaled by a factor of, for example, 1-5, or 5-50, before being inputted into the equation.

In embodiments in which the outdoor device is a hose reel, it will be understood that the reel will normally be supplied water with a source hose that is different than the hose spooled onto the reel. In these embodiments, the alert system can be configured to generate an alert if the Euclidean norm of the displacement vector (the net displacement of the outdoor device 2) is greater than the length of the source hose multiplied by some factor, such as 1-3, or perhaps 2.0. Movements of the outdoor device 2 in excess of, e.g., twice the length of the source hose might indicate theft (e.g., disconnecting the source hose from the faucet in order to steal the outdoor device).

In the preceding paragraphs, the comparison of the high threshold to the result of an equation having displacement or acceleration components along the axes as inputs was discussed. In some embodiments the vertical (z-axis) displacement or acceleration components were scaled by a multiplication factor before being inputted into the equation. Persons of ordinary skill in the art will recognize that these ideas are not exclusive, and that it would be possible to use an equation which has both the displacement and acceleration components as inputs, and that furthermore the vertical (z-axis) inputs might be scaled. For example, the high threshold could be compared to the weighted sum of the Euclidean norm of the acceleration vector and the Euclidean norm of the displacement vector, wherein the vertical (z-axis) displacement and acceleration components were each scaled by the same or different factors, such as 1-5, or 5-50, before use in the equation. Referring still to FIG. 16, if the answer to the inquiry in the decision step 204 is yes, then the method 220 proceeds to a step 211, which will be addressed in detail below. If the answer to the inquiry in the decision step 204 is no, then the method 220 proceeds to a decision step 205, in which the alert system determines whether or not there has been a motion event meeting or exceeding a “low threshold” within the last polling period.

In making this determination, the alert system compares motion data from the motion sensor 65 and compares it to stored low threshold data, for example using methods similar to those outlined above for the high threshold. In one embodiment, the motion sensor 65 is a three-axis accelerometer capable of orientation [same question as above] and motion detection, and the low threshold is preferably a relatively lower magnitude (compared to the corresponding high threshold) of the three-dimensional acceleration or displacement vectors. In other embodiments, meeting or exceeding the low threshold can alternatively or additionally mean that one, two, or all three of the magnitudes of the acceleration or displacement components along three separate axes (e.g., x-axis, y-axis, and z-axis) meet or exceed corresponding low thresholds for those axes. It will be understood that these low acceleration/displacement component thresholds can differ from one another. In certain implementations, a low vertical (z-axis) component acceleration or displacement threshold is less than the low horizontal (x- and y-axes) component acceleration/displacement thresholds of the three-dimensional acceleration/displacement vector by a factor of, for example, 1-5 or 5-50. In other implementations, the low threshold is compared to the result of an equation, such as a Euclidean norm, which uses the displacement and/or acceleration components along the axes as inputs. In one preferred embodiment, the vertical (z-axis) acceleration and/or displacement component is scaled by a factor of, for example, 1-5, or 5-50, before being inputted into the equation. In another embodiment, the Euclidean norm of the displacement vector (the net displacement of the outdoor device 2) is compared to the length of the source hose reel multiplied by some factor, such as 1-1.5, or 1.5 to 3.

If the answer to the inquiry in the decision step 205 is no, then the method 220 returns to the decision step 201. If the answer to the inquiry in the decision step 205 is yes, then the method 220 proceeds to a step 206, in which the polling rate is increased, for example by a factor of 1-10, or 10-100. In this embodiment, the polling rate refers to the frequency at which the alert system processes motion data from the motion sensor 65, and it is equal to the inverse of the polling period. In certain embodiments where a presence confirmation device 70 is also present, the rate at which the presence confirmation device 70 sends presence confirmation requests to the outdoor device 2 might also be increased in the step 206. For example, in one embodiment the motion event detected in step 205 causes the outdoor device 2 to inform the presence confirmation device 70 of the motion event (e.g., via a wireless signal), which triggers an increased presence confirmation polling rate. Additionally, in some embodiments, the alert system might generate a warning during the step 206, such as a flash of a light or an audio chirp through a speaker (e.g., speaker 183 of FIG. 14).

Next, in a step 207, the alert system waits the polling period, which was modified by the step 206. After waiting this period, the method 220 proceeds to a decision step 208, in which the alert system determines whether or not there has been a motion event meeting or exceeding a low threshold. The low threshold may be the same low threshold as in the step 205, or it may be a different value. If the answer to the inquiry in the decision step 208 is no, the method 220 proceeds to a decision step 209, in which the alert system determines if the time period since commencing the step 206 has reached a certain duration, for example 10-60 seconds, or 1-5 minutes. If the answer to the inquiry in the step 209 is no, the method 220 returns to the step 207. If the answer to the inquiry in the decision step 209 is yes, the method 220 proceeds to a step 210, in which the polling rate is reset to its original value. After resetting the polling rate in the step 210, the method 220 returns to the decision step 201.

If the answer to the inquiry in the decision step 208 is yes, the method 220 proceeds to the step 211, in which one or more alerts are generated. In some embodiments, the alert could be a conventional audible alert to warn the owner or user of the outdoor device. Alternatively, the alert could be non-audible, such as a flashing light, a signal capable of deactivating device controls, and/or a signal sent to a home security monitoring service. Persons of ordinary skill in the art will recognize than any combination of audible and non-audible alerts could be generated in the step 211.

Next, in a decision step 212, the alert system determines whether the alert status has been deactivated. In some embodiments, the alert status can be deactivated remotely by the presence confirmation system 70. In other embodiments, the alert status can be deactivated by a user inputting a passcode into the alert system. For example, if the outdoor device 2 contained the alert system 160 as shown in FIG. 12, the user could enter a passcode using buttons 161 to deactivate the alert status. In other embodiments, the alert status automatically deactivates after a certain length of time, for example 1-5 minutes, or 2-20 minutes. If the answer to the inquiry in the decision step 212 is no, the method 220 proceeds to a step 213, in which the alert status is maintained. In this case, the method 220 next returns to the decision step 212. If the answer to the inquiry in decision step 212 is yes, the method 220 proceeds to a step 214, in which the alert is stopped. In this case, the method 220 next proceeds to the step 210.

As noted above, step 201 of the method 220 detects whether the outdoor device 2 is in “normal usage.” In certain embodiments, the alert system is configured to deactivate (or at least suspend generating an alert or alarm) during normal usage. In alternative embodiments, the alert system can be configured to remain “on” and to generate alerts during normal usage of the outdoor device 2. For example, if the outdoor device 2 is a reel, normal usage of the reel might involve rotation of a reel drum without any substantial translation or acceleration of the reel. In this case, the detection of normal usage (e.g., rewinding or deploying of the linear material wound by the reel, flow of water through the hose if it is a hose reel, etc.) may simply cause the alert system to switch from a high security setting to a low security setting. For example, the alert system in the high security setting might be configured to trigger an alert or higher polling rate (described above) upon detecting relatively small translation or acceleration of the reel, while in the low security setting it might require a greater translation or acceleration in order to trigger the alert or higher polling rate.

FIG. 17 is a flowchart of an embodiment of an alternative method 280 of operating an alert system of the outdoor device 2. The method is applicable whether or not the alert system has the presence confirmation device 70 of FIG. 6. It will be understood that not all of the illustrated steps are required, and that this method can be modified without departing from the spirit and scope of the invention. The illustrated method 280, depicted from the point of view of the alert system of the outdoor device 2, starts at 250. In an ensuing step 251, the alert system determines if the outdoor device 2 is being used in normal operation by a user. In making this determination, a variety of factors can be evaluated. In some embodiments, whether or not the reel 120 of FIG. 9 is in motion will be a factor. If the answer to the inquiry in the decision step 251 is yes, then the method 280 proceeds to a step 252, in which the alert system waits a time period, for example 1-10 seconds, or 10-30 seconds. In this case, the method 280 then returns to the decision step 251.

If the answer to the inquiry in the decision step 251 is no, then the method 280 proceeds to a step 253, in which the alert system waits the polling period, for example 0.1-1 second, or 1-10 seconds. After waiting the polling period, the method 280 proceeds to a decision step 254, in which the alert system determines whether or not there has been a motion event meeting or exceeding a high threshold within the last polling period. In making this determination, the alert system compares motion data from the motion sensor 65 and compares it to a stored high threshold. Detecting satisfaction of a high threshold can be achieved using one or more of the methods described above in connection with FIG. 16.

If the answer to the inquiry in the decision step 254 is yes, then the method 280 proceeds to a step 266, which will be addressed in detail later in this description. If the answer to the inquiry in the decision step 254 is no, then the method 280 proceeds to a decision step 255, in which the alert system determines whether or not there has been a motion event meeting or exceeding a low threshold within the last polling period. In making this determination, the alert system compares motion data from the motion sensor 65 and compares it to a stored low threshold. Detecting satisfaction of a low threshold can be achieved using one or more of the methods described above in connection with FIG. 16.

If the answer to the inquiry in the decision step 255 is no, then the method 280 returns to the decision step 251. If the answer to the inquiry in the decision step 255 is yes, then the method 220 proceeds to a step 256, in which the polling rate is increased, for example by a factor of 1-10, or 10-100. Also at the step 256, the method 280 can increase a count, beginning at zero, by one. In certain embodiments where a presence confirmation device 70 is also present, the rate at which the presence confirmation device 70 sends presence confirmation requests to the outdoor device 2 might also be increased in the step 256. For example, in one embodiment the motion event detected in step 255 causes the outdoor device 2 to inform the presence confirmation device 70 of the motion event (e.g., via a wireless signal), which triggers an increased presence confirmation polling rate. Additionally, in some embodiments, the alert system might generate a warning during the step 256, such as a flash of a light or an audio chirp through a speaker.

Next, in a step 257, the alert system waits the polling period, which was modified by the step 256. After waiting this period, the method 280 proceeds to a decision step 258, in which the alert system determines whether or not there has been a motion event meeting or exceeding a high threshold within the last polling period. In making this determination, the alert system compares motion data from the motion sensor 65 to a stored high threshold. The discussion of the high threshold above in the step 254 applies here. However, the high threshold used in the step 258 may be the same or different than the high threshold used in the step 254.

If the answer to the inquiry in the decision step 258 is yes, then the method 280 proceeds to the step 266, which will be addressed in detail later in this description. If the answer to the inquiry in the decision step 258 is no, then the method 280 proceeds to a decision step 259, in which the alert system determines whether or not there has been a motion event meeting or exceeding a low threshold within the last polling period. In making this determination, the alert system compares motion data from the motion sensor 65 to a stored low threshold. The discussion of the low threshold above in the step 255 applies here. However, the low threshold used in the step 259 may be the same or different than the low threshold used in the step 255.

If the answer to the inquiry in the decision step 259 is no, then the method 280 proceeds to a decision step 260, in which the alert system determines if the time period since commencing the step 256 has reached a certain duration, for example 10-60 seconds, or 1-5 minutes. If the answer to the inquiry in the decision step 260 is no, the method 280 returns to the step 257. If the answer to the inquiry in the decision step 260 is yes, the method 280 proceeds to a step 261, in which the polling rate is reset to its original value. Additionally at this step, the count is reset to zero. After resetting the polling rate and the count in the step 261, the method 280 returns to the decision step 251.

If the answer to the inquiry in the decision step 259 is yes, then the method 280 proceeds to a decision step 270, in which the alert system determines if the count has exceeded a certain value, for example 0-3, or 3-5. If the answer to the inquiry in the decision step 270 is no, the method 280 returns to the step 256.

If the answer to the inquiry in the decision step 270 is yes, then the method 280 proceeds to a step 262, in which the polling rate is further increased (beyond the increase that took place in the step 256), for example by a factor of 1-10, or 10-100. In certain embodiments where a presence confirmation device 70 is also present, the rate at which the device 70 sends presence confirmation requests to the outdoor device 2 might also be increased in the step 262. For example, in one embodiment the motion event detected in step 259 causes the outdoor device 2 to inform the presence confirmation device 70 of the motion event (e.g., via a wireless signal), which triggers an increased presence confirmation polling rate. Additionally, in some embodiments, the alert system might generate a warning during the step 262, such as a flash of a light or an audio chirp through a speaker.

Next, in a step 263, the alert system waits the polling period, which was modified by the step 262. After waiting this period, the method 280 proceeds to a decision step 264, in which the alert system determines whether or not there has been a motion event exceeding a low threshold. The low threshold may be the same low threshold as in the step 255 or the step 259, or it may be a different value. If the answer to the inquiry in the decision step 264 is no, the method 280 proceeds to a decision step 265, in which the alert system determines if the time period since commencing the step 256, or in an alternative embodiment the step 262, has reached a certain duration, for example 10-60 seconds, or 1-5 minutes. If the answer to the inquiry in the decision step 265 is no, the method 280 returns to the step 263. If the answer to the inquiry in the decision step 265 is yes, the method 220 proceeds to the step 261.

If the answer to the inquiry in the decision step 264 is yes, the method 280 proceeds to the step 266, in which one or more alerts are generated. In some embodiments, the alert could be a conventional audible alert to warn the owner or user of the outdoor device. Alternatively, the alert could be non-audible, such as a flashing light, a signal capable of deactivating device controls, and/or a signal sent to a home security monitoring service. Persons of ordinary skill in the art will recognize than any combination of audible and non-audible alerts could be generated in the step 266.

Next, in a decision step 267, the alert system determines whether the alert status has been deactivated. In some embodiments, the alert status can be deactivated remotely by the presence confirmation system 70. In other embodiments, the alert status can be deactivated by a user inputting a passcode into the alert system. For example, if the outdoor device 2 contained the alert system 160 as shown in FIG. 12, the user could enter a passcode using buttons 161 to deactivate the alert status. In other embodiments, the alert status automatically deactivates after a certain length of time, for example 1-5 minutes, or 2-20 minutes. If the answer to the inquiry in the decision step 267 is no, the method 280 proceeds to a step 268, in which the alert status is maintained. In this case, the method 280 next returns to the decision step 267. If the answer to the inquiry in decision step 267 is yes, the method 280 proceeds to a step 269, in which the alert is stopped. In this case, the method 280 next proceeds to the step 261.

In FIGS. 16 and 17, the method of operating an alert system utilizes steps comparing motion data to a high threshold and to a low threshold. Persons of ordinary skill in the art will recognize similar methods may be implemented using a larger number of thresholds, or implemented with a single threshold. In particular, one possible modification of the method of FIG. 17 involves omitting the decision steps 254 and 258. In other words, after the method 280 completes the step 253, the method 280 proceeds directly to the decision step 255. Similarly, after the method 280 completes the step 257, the method 280 proceeds directly to the decision step 259. One preferred version of this embodiment uses a count value of 0-3, or 4-6. The modification described above could also be applied to the method of FIG. 16 by omitting the decision step 204. In other words, after the method 220 completes the step 203, the method 220 proceeds directly to the decision step 205.

While the above discussion of the systems and methods illustrated in FIGS. 16 and 17 involve the use of a three-axis accelerometer, other embodiments may employ a combination of multiple accelerometers as an alternative to a single three-axis accelerometer. For example, the system can employ three single-axis accelerometers, or one single-axis accelerometer and one double-axis accelerometer. These alternatives can be employed to provide all of the same information and functionality of a three-axis accelerometer.

FIG. 18 illustrates a state diagram 300 of one embodiment of the alert system of the outdoor electrical device 2. The illustrated state diagram 300 would be suitable for many embodiments of the alert system which have a passcode. The state diagram 300 could be implemented in an alert system such as the alert system 160 in FIG. 12, and it might contain the alarm circuitry 163 as illustrated in FIG. 15. In that case, the microcontroller 420 would implement the logic of the state diagram 300 in response to input from the user on the buttons 421.

With reference to FIG. 18, the alert system begins in a state 301, in which the alert system awaits user input. If a user enters a request to change the passcode, which in some embodiments could be done by holding down one or more of the buttons 421 in FIG. 15 for a designated length of time, the alert system undergoes a state transition 304 to a state 303. In the state 303, the alert system waits for the user to enter an old passcode. In some embodiments, the old passcode can be stored in the memory of the microcontroller 420 of FIG. 15. If the user has never entered a passcode before, the old passcode is preferably a default passcode. If a certain time period elapses without the user entering the old passcode, for example 10-20 seconds, or if the user enters the old passcode incorrectly, the alert system undergoes a state transition 305 to the state 301. On the other hand, if the user enters the old passcode correctly, the alert system undergoes a state transition 307 to a state 306.

In the state 306, the alert system waits for the user to enter a new passcode. If a certain time period elapses without the user entering the new passcode, for example 10-20 seconds, the alert system undergoes a state transition 308 to the state 301. On the other hand, if the user enters a new passcode within the time period, the alert system undergoes a state transition 310 to a state 309. In the state 309, the alert system stores the new passcode. In some embodiments, the new passcode can be stored in the memory of the microcontroller 420 of FIG. 15. After storing the new passcode, the alert system undergoes a transition 311 to the state 301 without any need for user action.

With continuing reference to FIG. 18, the user may also request reset of the passcode from the state 301. If a user requests reset of the passcode, which in some embodiments can be done by holding down one or more of the buttons 421 in FIG. 15 for a designated length of time, the alert system undergoes a state transition 321 to a state 320. In the state 320, the alert system waits for the user to enter a factory restore code. In some embodiments, the factory restore code can be stored in the memory of the microcontroller 420 of FIG. 15. If a certain time period elapses without the user entering the factory restore code, for example 10-20 seconds, or if the user enters the factory restore code incorrectly, the alert system undergoes a state transition 322 to the state 301. On the other hand, if the user enters the factory restore code correctly, the alert system undergoes a state transition 324 to a state 323.

In the state 323, the alert system resets the passocode to the default passcode, as discussed above with reference to the state 303. After resetting the passcode to the default passcode, the alert system undergoes a transition 325 to the state 301 without any need for user action.

With continuing reference to FIG. 18, the user may also request to arm the alert system from the state 301. If the user requests to arm the alert system, which in some embodiments can be done by holding down one or more of the buttons 421 in FIG. 15 for a designated length of time, the alert system undergoes a state transition 315 to a state 302. In other embodiments, the user requests to arm the alert system by entering the passcode.

Once the alert system is in the state 302, the system is armed. At this point the alert system can be further operated by methods such as those illustrated in FIGS. 16 and 17. If a user requests to disarm the alert system, which in some embodiments can be done by entering the passcode, the alert system undergoes a state transition 315 to the state 301. In one embodiment, if the user incorrectly enters the passcode a certain number of times, such as 3-6 times, the alert system generates an alert. In some embodiments, the alert generated is similar to that in the step 211 of FIG. 16.

In some embodiments of the alert system illustrated in FIG. 18, the alert system produces sounds or flashes lights when in or transitioning between the states of the state diagram 300. Thus, for example, when the alert system undergoes the transition 315 from the state 301 to the state 302, the alert system may produce a series of beeps and sounds to indicate that the alert system is armed.

In some embodiments in which the outdoor device 2 is a hose reel, the alert system is configured to consider water flow as a data item for determining whether to generate an alert or alarm. A hose reel typically has to be connected to a fluid source (e.g., a house's outdoor water faucet), normally by a source hose. In such cases, a thief typically has to disconnect the hose reel from the fluid source in order to steal the hose reel. Thus, the detection of water flow through the hose reel is highly inconsistent with attempted theft. In certain embodiments, one or more fluid pressure sensors and/or flow sensors are provided along the flow path from the fluid source to the distal end of a hose spooled onto the hose reel. Such sensors can be provided in, e.g., the source hose, the hose reel, the hose spooled onto the hose reel, and/or joints therebetween. The alert system can be configured to prevent the generation of an alert or alarm when the flow sensors and/or pressure sensors detect fluid flow above a threshold. A flow sensor can comprise a flow rate sensor, or more simply a flow detector. An example of a flow detector is a propeller device that has a rotatable component at least partially submerged in the fluid flow, wherein the rotatable component rotates when the fluid is flowing. In one embodiment, the alert system is configured to prevent the generation of an alert or alarm when the rotatable component of the propeller device rotates at an angular velocity less than a defined threshold.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above, but should be determined only by a fair reading of the claims that follow.

1. An apparatus, comprising:
a body that is substantially stationary during normal usage of the apparatus;
a motion sensor configured to measure motion data from which translation of the body can be determined; and
an alert system having an armed state and a disarmed state, wherein in the armed state the alert system is configured to:
receive the motion data from the motion sensor;
use the received motion data to detect a net translation of the body; and
respond to a determination that the net translation of the body is greater than or equal to a defined threshold by generating an alert or by increasing a polling rate at which the alert system periodically receives new motion data from the motion sensor.

2. The apparatus of claim 1, wherein the body comprises a portion of a reel for spooling a linear material.

3. The apparatus of claim 1, wherein the motion sensor comprises an accelerometer.

4. The apparatus of claim 1, wherein the defined threshold is a high threshold, the alert system configured to:
respond to a determination that the net translation of the body is greater than or equal to the high threshold by generating the alert; and
respond to a determination that the net translation of the body is less than the high threshold but greater than or equal to a low threshold by increasing the polling rate at which the alert system periodically receives new motion data from the motion sensor.

5. The apparatus of claim 4, wherein, after said increasing the polling rate, the alert system is configured to:
receive new motion data from the motion sensor;
use the received new motion data to detect a new net translation of the body; and
respond to a determination, within a defined time period after said increasing of the polling rate, that the new net translation of the body is greater than or equal to the low threshold by generating the alert.

6. The apparatus of claim 1, wherein the apparatus, in normal usage, involves the performance of a function achieved by movement of a portion of the apparatus, the alert system configured to remain in the armed state during normal usage of the apparatus.

7. The apparatus of claim 6, wherein the alert system is configured to prevent generating the alert or increasing the polling rate during said normal usage.

8. The apparatus of claim 1, wherein the alert system is configured to:
use the received motion data to detect a first component of the net translation of the body along a first axis;
use the received motion data to detect a second component of the net translation of the body along a second axis;
use the received motion data to detect a third component of the net translation of the body along a third axis, the first, second, and third axes having different orientations angularly separated by 90° from one another; and
determine whether the first component of the net translation of the body is greater than or equal to a defined threshold for the first axis;
determine whether the second component of the net translation of the body is greater than or equal to a defined threshold for the second axis;
determine whether the third component of the net translation of the body is greater than or equal to a defined threshold for the third axis; and
respond to a determination that any of said net translation components is greater than or equal to its corresponding threshold by generating an alert or by increasing a polling rate at which the alert system periodically receives new motion data from the motion sensor.

9. The apparatus of claim 1, wherein the alert system is configured to:
use the received motion data to detect a first component of the net translation of the body along a first axis;
use the received motion data to detect a second component of the net translation of the body along a second axis;
use the received motion data to detect a third component of the net translation of the body along a third axis, the first, second, and third axes having different orientations angularly separated by 90° from one another;
compute a magnitude of a motion vector consisting of the first, second, and third net translation components; and
respond to a determination that the computed magnitude of the motion vector is greater than or equal to a defined vector magnitude threshold by generating an alert or by increasing a polling rate at which the alert system periodically receives new motion data from the motion sensor.

10. The apparatus of claim 1, wherein the alert system does not generate an alert or increase said polling rate if the net translation of the body is nonzero but less than the defined threshold.

11. A presence confirmation system for one or more electrical devices, comprising:
at least one electrical device; and
a presence confirmation device configured to repeatedly send wireless query signals to the electrical device;
wherein the electrical device is configured to receive the query signals from the presence confirmation device, the electrical device configured to respond to receiving each query signal by sending a wireless confirmation signal to the presence confirmation device, the presence confirmation device configured to generate an alert if the presence confirmation device does not receive the confirmation signal within a certain time period after sending a query signal to the electrical device.

12. (canceled)

13. The presence confirmation system of claim 11, wherein the electrical device is programmed to be inoperable if the electrical device does not receive a query signal from the presence confirmation device for a certain period of time.

14. (canceled)

15. The presence confirmation system of claim 11, wherein the electrical device comprises a motorized reel for spooling linear material.

16. The presence confirmation system of claim 15, wherein the linear material comprises a hose, the electrical device further comprising:
a valve system for controlling fluid flow through the hose; and
a remote control configured to control the valve system and to control winding and unwinding of the motorized reel.

17-28. (canceled)

29. The presence confirmation system of claim 11, wherein the presence confirmation device is configured to generate the alert only if (1) the presence confirmation device receives a wireless motion sensor signal from a motion sensor of the electrical device, the motion sensor signal indicative of a movement of the electrical device, and (2) the presence confirmation device does not receive the confirmation signal within said certain time period after sending said query signal to the electrical device, wherein the query signal was sent after the presence confirmation device received the motion sensor signal.

30-31. (canceled)

32. An apparatus comprising:
an electrical device;
a transceiver on or within the electrical device, the transceiver configured to receive a wireless query signal, the transceiver configured to respond to receiving the query signal by transmitting a wireless confirmation signal; and
an electronics component configured to disable the electrical device if the electrical device does not receive a query signal for a certain period of time.

33. The apparatus of claim 32, wherein the transceiver is configured to receive the wireless query signal from a presence confirmation device, the transceiver configured to respond to receiving the query signal by transmitting a wireless confirmation signal to the presence confirmation device, the electronics component configured to disable the electrical device if the electrical device does not receive a query signal from the presence confirmation device for a certain period of time.

34. The apparatus of claim 32, further comprising a motion sensor configured to detect motion of the electrical device and respond to said motion by transmitting a wireless motion sensor signal indicative of the detected motion.

35. The apparatus of claim 34, wherein the electrical device includes an alert generator configured to generate an alert if the motion sensor detects motion of the electrical device.

36. The apparatus of claim 35, wherein the alert generator generates an alert only if (1) the motion sensor detects motion of the electrical device, and (2) within a predefined time period after the detected motion, the transceiver fails to receive a wireless query signal having a signal strength above a predefined threshold.

37-59. (canceled)
